(19) United States
(12) Patent Application Publication
(10) Pub. No.: US 2024/0356687 A1
(43) Pub. Date: Oct. 24, 2024

(54) TIME SENSITIVE NETWORKING SUPPORT IN A 5G SYSTEM

(71) Applicant: QUALCOMM Incorporated, San Diego, CA (US)

(72) Inventors: Sebastian SPEICHER, Wallisellen (CH); Kefeng ZHANG, Beijing (CN); Huichun LIU, San Diego, CA (US); Lenaig Genevieve CHAPONNIERE, La Jolla, CA (US); Suli ZHAO, San Diego, CA (US); Erin WU, San Diego, CA (US)

(21) Appl. No.: 18/560,073

(22) PCT Filed: Jul. 22, 2021
(86) PCT No.: PCT/CN2021/107776

§ 371 Date: Nov. 9, 2023

(51) Int. Cl. H04L 5/00; H04B 7/185; H04L 7/00

(52) U.S. Cl. CPC H04L 5/0005; H04B 7/1855; H04L 7/0008

(57) ABSTRACT

This disclosure provides systems, methods and apparatus, including computer programs encoded on computer storage media, for supporting an interface between a system that implements sensitive networking (TSN) and a wireless communications system. In one aspect, a network entity, which may be configured to communicate over the wireless communications system, may interface with one or more TSN bridges of the TSN system. The network entity may share timing information with a centralized network configuration (CNC) entity of the TSN system and may perform a time domain mapping between a first clock used by the CNC entity and a second clock used by the network entity. For example, the network entity may map absolute times using a clock drift between the first clock and the second clock and may convert time durations using a cumulative rate ratio between the first clock and the second clock.

### CROSS REFERENCE

The present application is a 371 national stage filing of International PCT Application No. PCT/CN2021/107776 by SPEICHER et al. entitled “TIME SENSITIVE NETWORKING SUPPORT IN A 5G SYSTEM,” filed Jul. 22, 2021, which is assigned to the assignee hereof, and which is expressly incorporated by reference in its entirety herein.

### FIELD OF TECHNOLOGY

The following relates to wired or wireless communications, including time sensitive networking (TSN) support in a 5G system (5GS).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some systems, such as time sensitive networking (TSN) systems, a central manager may control time scheduling of signaling between different components to provide deterministic messaging. For example, a central manager within a TSN system may schedule messaging such that information travels between different points or components in a fixed amount of time.

### SUMMARY

The described techniques relate to improved methods, systems, devices, and apparatuses that support time sensitive networking (TSN) support in a 5G system (5GS). Generally, the described techniques provide for a mapping between a first clock used by a centralized network configuration (CNC) entity of a TSN system that is configured to communicate over a wired communications system and a second clock used by a network entity that is configured to communicate over a wired or wireless communications system, such as a 5GS. For example, the TSN system may interface with a wireless communications system (e.g., the wireless communications system may function as or otherwise fill a similar role as a bridge between a transmitter and a receiver within the TSN system) and the TSN system and the wireless communications system may lack a shared or common sense of time. As such, to ensure that communicating components employ a shared or common sense of time, the network entity may perform a mapping between the first clock used by the CNC and the second clock used by the network entity. The first clock may be used for timing control information (e.g., gate scheduling information, propagation delays, or any other timing information that may be useful for scheduling messages within the TSN system). The network entity may communicate over the wired or wireless communications system in accordance with a gate schedule and based on performing the mapping. In some examples, a device-side TSN translator (DS-TT) or a network-side TSN translator (NW-TT) may perform the mapping between the first clock and the second clock. Additionally or alternatively, a TSN application function (AF) entity may perform the mapping between the first clock and the second clock.

A method for wireless communication at a network entity is described. The method may include receiving, from a TSN clock manager, one or more messages indicating a first clock used by a CNC entity configured to coordinate communications in a wired communications network that implements TSN, performing a time domain mapping between the first clock used by the CNC entity and a second clock used by the network entity that is configured to communicate over a wired or wireless communications network, and communicating, by the network entity and over the wired or wireless communications network, one or more signals based on timing control information associated with the TSN and performing the time domain mapping.

An apparatus for wireless communication at a network entity is described. The apparatus may include a processor, memory coupled with the processor, and instructions stored in the memory. The instructions may be executable by the processor to cause the apparatus to receive, from a TSN clock manager, one or more messages indicating a first clock used by a CNC entity configured to coordinate communications in a wired communications network that implements TSN, perform a time domain mapping between the first clock used by the CNC entity and a second clock used by the network entity that is configured to communicate over a wired or wireless communications network, and communicating, by the network entity and over the wired or wireless communications network, one or more signals based on timing control information associated with the TSN and performing the time domain mapping.

Another apparatus for wireless communication at a network entity is described. The apparatus may include means for receiving, from a TSN clock manager, one or more messages indicating a first clock used by a CNC entity configured to coordinate communications in a wired communications network that implements TSN, means for performing a time domain mapping between the first clock used by the CNC entity and a second clock used by the network entity that is configured to communicate over a wired or wireless communications network, and means for communicating, by the network entity and over the wired or wireless communications network, one or more signals based on timing control information associated with the TSN and performing the time domain mapping.

A non-transitory computer-readable medium storing code for wireless communication at a network entity is described. The code may include instructions executable by a processor to receive, from a TSN clock manager, one or more messages indicating a first clock used by a CNC entity configured to coordinate communications in a wired communications network that implements TSN, perform a time domain mapping between the first clock used by the CNC entity and a second clock used by the network entity that is configured to communicate over a wired or wireless communications network, and communicating, by the network entity and over the wired or wireless communications network, one or more signals based on timing control information associated with the TSN and performing the time domain mapping.

Some examples of the method, apparatuses, and non-transitory computer-readable medium described herein may further include operations, features, means, or instructions for calculating, by a DS-TT or an NW-TT of the network entity, a clock drift and a cumulative rate ratio between the first clock and the second clock based on receiving the one or more messages indicating the first clock used by the CNC entity and a clock domain number corresponding to the first clock used by the CNC entity, where performing the time domain mapping may be based on calculating the clock drift and the cumulative rate ratio.

Some examples of the method, apparatuses, and non-transitory computer-readable medium described herein may further include operations, features, means, or instructions for receiving, from the CNC entity, the timing control information that includes gate schedule timing information and gate schedule cycle information defined in accordance with the first clock used by the CNC entity, where communicating the one or more signals may be based on receiving the timing control information.

In some examples of the method, apparatuses, and non-transitory computer-readable medium described herein, performing the time domain mapping may include operations, features, means, or instructions for mapping the gate schedule timing information from the first clock used by the CNC entity to the second clock used by the network entity based on the clock drift between the first clock and the second clock and mapping the gate schedule cycle information from the first clock used by the CNC entity to the second clock used by the network entity based on the cumulative rate ratio between the first clock and the second clock.

Some examples of the method, apparatuses, and non-transitory computer-readable medium described herein may further include operations, features, means, or instructions for measuring a propagation delay between the DS-TT or the NW-TT and a next hop ethernet station, where the measuring may be performed using the second clock, and where the timing control information includes the propagation delay.

In some examples of the method, apparatuses, and non-transitory computer-readable medium described herein, performing the time domain mapping may include operations, features, means, or instructions for mapping the propagation delay from the second clock used by the network entity to the first clock used by the CNC entity based on the cumulative rate ratio between the first clock and the second clock.

Some examples of the method, apparatuses, and non-transitory computer-readable medium described herein may further include operations, features, means, or instructions for transmitting, to the CNC entity via a TSN AF entity, the propagation delay defined in accordance with the first clock used by the CNC entity, where the timing control information may be based on the propagation delay between the DS-TT or the NW-TT and the next hop ethernet station.

Some examples of the method, apparatuses, and non-transitory computer-readable medium described herein may further include operations, features, means, or instructions for receiving an indication of the clock domain number corresponding to the first clock used by the CNC entity and processing the one or more messages based on receiving the indication of the clock domain number.

In some examples of the method, apparatuses, and non-transitory computer-readable medium described herein, the clock domain number may be received from the CNC entity via a TSN AF entity.

In some examples of the method, apparatuses, and non-transitory computer-readable medium described herein, the clock domain number corresponding to the first clock used by the CNC entity may be pre-configured at the DS-TT or the NW-TT.

Some examples of the method, apparatuses, and non-transitory computer-readable medium described herein may further include operations, features, means, or instructions for transmitting, by a TSN AF entity of the network entity and to a session management function (SMF) entity of the network entity, a request for a clock drift and a cumulative rate ratio between the first clock and the second clock, the request associated with a clock domain number corresponding to the first clock used by the CNC entity and receiving, from the SMF entity and based on the request associated with the clock domain number corresponding to the first clock, the clock drift and the cumulative rate ratio between the first clock and the second clock, where performing the time domain mapping may be based on receiving the clock drift and the cumulative rate ratio.

Some examples of the method, apparatuses, and non-transitory computer-readable medium described herein may further include operations, features, means, or instructions for receiving, from the CNC entity, the timing control information that includes gate schedule timing information and gate schedule cycle information defined in accordance with the first clock used by the CNC entity, where communicating the one or more signals may be based on receiving the timing control information includes.

In some examples of the method, apparatuses, and non-transitory computer-readable medium described herein, performing the time domain mapping may include operations, features, means, or instructions for mapping the gate schedule timing information from the first clock used by the CNC entity to the second clock used by the network entity based on the clock drift between the first clock and the second clock and mapping the gate schedule cycle information from the first clock used by the CNC entity to the second clock used by the network entity based on the cumulative rate ratio between the first clock and the second clock.

Some examples of the method, apparatuses, and non-transitory computer-readable medium described herein may further include operations, features, means, or instructions for transmitting, to a DS-TT or an NW-TT, the gate schedule timing information and the gate schedule cycle information defined in accordance with the second clock used by the network entity.

Some examples of the method, apparatuses, and non-transitory computer-readable medium described herein may further include operations, features, means, or instructions for receiving, from a DS-TT or an NW-TT, a propagation delay between the DS-TT or the NW-TT and a next hop ethernet station, the propagation delay defined in accordance with the second clock used by the network entity, where the timing control information includes the propagation delay, where the timing control information may be based on the propagation delay between the DS-TT or the NW-TT and the next hop ethernet station.

In some examples of the method, apparatuses, and non-transitory computer-readable medium described herein, performing the time domain mapping may include operations, features, means, or instructions for mapping the propagation delay from the second clock used by the network entity to the first clock used by the CNC entity based on the cumulative rate ratio between the first clock and the second clock.

Some examples of the method, apparatuses, and non-transitory computer-readable medium described herein may further include operations, features, means, or instructions for transmitting, to the CNC entity, the propagation delay defined in accordance with the first clock used by the CNC entity.

Some examples of the method, apparatuses, and non-transitory computer-readable medium described herein may further include operations, features, means, or instructions for receiving, from the SMF entity and based on the request associated with the clock domain number corresponding to the first clock, an updated clock drift and an updated cumulative rate ratio between the first clock and the second clock and performing, for the timing control information, an updated time domain mapping between the first clock associated with the CNC entity and the second clock used by the network entity.

### BRIEF DESCRIPTION OF THE DRAWINGS

FIG. 1 illustrates an example of a wireless communications system that supports time sensitive networking (TSN) support in a 5G system (5GS) in accordance with aspects of the present disclosure.

FIG. 2 illustrates an example of a TSN system that supports TSN support in a 5GS in accordance with aspects of the present disclosure.

FIG. 3 illustrates an example of a bridge interface that supports TSN support in a 5GS in accordance with aspects of the present disclosure.

FIGS. 4 and 5 illustrate examples of process flows that support TSN support in a 5GS in accordance with aspects of the present disclosure.

FIGS. 6 and 7 show block diagrams of devices that support TSN support in a 5GS in accordance with aspects of the present disclosure.

FIG. 8 shows a block diagram of a communications manager that supports TSN support in a 5GS in accordance with aspects of the present disclosure.

FIG. 9 shows a diagram of a system including a device that supports TSN support in a 5GS in accordance with aspects of the present disclosure.

FIGS. 10 through 12 show flowcharts illustrating methods that support TSN support in a 5GS in accordance with aspects of the present disclosure.

### DETAILED DESCRIPTION

In some systems, such as time sensitive networking (TSN) systems, a central manager may control time scheduling of signaling between different components to provide deterministic messaging. For example, a central manager within a TSN system may schedule messaging such that information or packets travel between different points or components in a fixed and predictable amount of time. In some aspects, such a central manager may be an example of a centralized network configuration (CNC) entity. A TSN system may rely on a common sense of time between communicating components to ensure that signals are communicated according to timing information associated with the TSN. In some examples, such as in examples in which the TSN interfaces with a wireless communications system (e.g., a 5G system (5GS)), a network entity of the wireless communications system may use a different clock than the CNC entity of the TSN system. The network entity may nonetheless receive timing control information from the CNC entity that is based on the clock for the TSN (e.g., the first clock), which may result in a mis-interpretation of the timing control information, as the network entity may interpret the timing control information using its own clock even though the timing control information was calculated, measured, or otherwise determined using a different clock (e.g., the TSN system clock). Such a mis-interpretation of timing control information may lead to inefficient gate scheduling or a lack of determinism for the TSN system, which may result in reduced user experience and sub-optimal performance.

In some implementations of the present disclosure, the network entity of or associated with the wireless communications system may perform a mapping (e.g., a time domain mapping or conversion) between a first clock used by the CNC entity (and the TSN system) and a second clock used by the network entity (and the wireless communications system). The network entity may include or be an example of a device-side TSN translator (DS-TT), a network-side TSN translator (NW-TT), or a TSN application function (AF) entity, or any combination thereof. As such, one or more of the DS-TT, the NW-TT, or the TSN AF may perform the mapping between the first clock and the second clock. The DS-TT, the NW-TT, or the TSN AF may perform the mapping for timing control information received from the CNC entity or for propagation delay measurements made at the network entity, or both. In some examples, the operations of the network entity may vary depending on which of the DS-TT, the NW-TT, or the TSN AF performs the mapping.

In examples in which the DS-TT or the NW-TT performs the mapping, the DS-TT or the NW-TT may receive or select (e.g., based on a pre-configuration) a clock domain number that is associated with the first clock used by the CNC entity and may use the clock domain number along with one or more messages from the CNC entity to identify or otherwise determine the first clock. The DS-TT or the NW-TT may calculate a clock drift (e.g., a delta) between the first clock and the second clock and a cumulative rate ratio (e.g., a frequency difference) between the first clock and the second clock and may use the clock drift and the cumulative rate ratio to perform the mapping. In examples in which the TSN AF performs the mapping, the TSN AF may select (e.g., based on a pre-configuration) a clock domain number and may subscribe to a session management function (SMF) entity or a user plane function (UPF) entity for clock drift and cumulative rate ratio information between the first clock associated with the selected clock domain number and the second clock used by the network entity. The TSN AF may use the clock drift and the cumulative rate ratio to perform the mapping.

Particular implementations of the subject matter described in this disclosure can be implemented to realize one or more of the following potential advantages. For example, as a result of performing the mapping between the first clock used by the CNC entity and the second clock used by the network entity, the network entity may correctly interpret the timing control information received from the CNC entity such that the network entity may implement gate scheduling and flow management with time synchronization with the CNC entity and the TSN system. For example, as a result of correctly interpreting the timing control information received from the CNC entity, the network entity may open one or more gates for data traffic (e.g., gates associated with different TSN or Ethernet traffic classes) at a starting time and for time durations expected by the CNC entity and other components of the TSN system. Further, as a result of converting time durations associated with propagation delay measurements from the second clock used by the network entity to the first clock used by the CNC entity, the CNC entity may correctly interpret the propagation delay measurements made at the network entity and may configure more accurate gate scheduling in accordance with the correctly interpreted propagation delay measurements. Such more accurate gate scheduling may facilitate a greater likelihood for successful communication, which may result in greater system throughput and higher data rates, among other benefits.

Aspects of the disclosure are initially described in the context of wireless communications systems. Additionally, aspects of the disclosure are illustrated by and described with reference to a TSN system, a bridge interface, and process flows. Aspects of the disclosure are further illustrated by and described with reference to apparatus diagrams, system diagrams, and flowcharts that relate to TSN support in a 5GS.

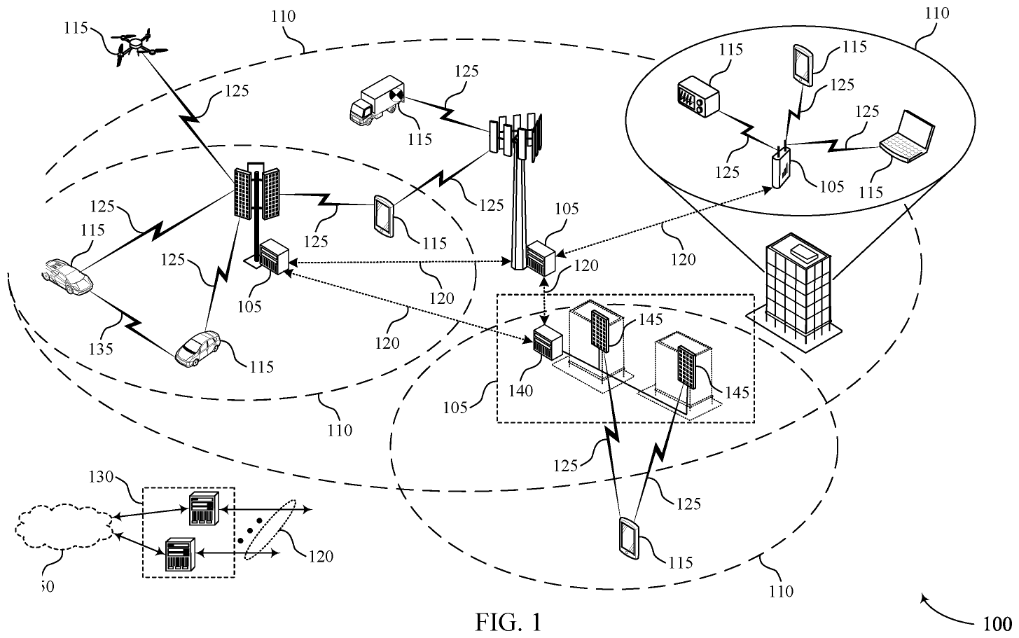

FIG. 1 illustrates an example of a wireless communications system 100 that supports TSN support in a 5GS in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a geographic coverage area 110 over which the UEs 115 and the base station 105 may establish one or more communication links 125. The geographic coverage area 110 may be an example of a geographic area over which a base station 105 and a UE 115 may support the communication of signals according to one or more radio access technologies.

The UEs 115 may be dispersed throughout a geographic coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, sometimes in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the wireless communications system 100 may include or interface with a wired network (or with one or more components of a wired network), such as an Ethernet network or other wired network that implements a TSN. The wired network may feature a central manager, such as a CNC entity, that configures scheduling timelines or otherwise provides timing control information to one or more components of the wired network and, in some examples, to one or more components of the wireless communications system 100. For example, the wired network (e.g., the Ethernet network or the other wired network that implements TSN) may include one or more hops between a talker (e.g., a transmitting device) and a listener (e.g., a receiving device) and at least one of the one or more hops may be via a network entity over a wireless communications link.

The network entity may be an example of one or more components of or functionalities associated with a UE 115, a base station 105, a TRP, a relay node, or any other device that is capable of wireless communication. In some examples, the network entity may operate according to a different clock than the CNC entity and the TSN system. For example, the CNC entity and the TSN system may use a first clock associated with a first absolute reference time (e.g., a first starting time or a first absolute time instance from which the first clock counts) and a first frequency (e.g., a first quantity of clock ticks per unit time) and the network entity may use a second clock associated with a second absolute reference time (e.g., a second starting time or a second absolute time instance from which the second clock counts) and a second frequency (e.g., a second quantity of clock ticks per unit time).

In some implementations, the network entity may perform a mapping or a conversion between the first clock used by the CNC entity and the second clock used by the network entity to support time synchronization and a common sense of time between the network entity and the CNC entity. The network entity may calculate, receive an indication of, obtain, or otherwise determine a clock drift between the first clock and the second clock and may calculate, receive an indication of, obtain, or otherwise determine a frequency or rate ratio between the first clock and the second clock and may perform the mapping or the conversion using one or both of the clock drift and the frequency or rate ratio. The clock drift may refer to a difference between absolute time instances obtained from the first clock and the second clock simultaneously, and may be referred to or understood as an offset (e.g., a time domain offset) between the first clock and the second clock. The frequency or rate ratio may refer to a ratio between the first frequency of the first clock and the second frequency of the second clock, and may be referred to or understood as a cumulative rate ratio.

In some examples, the techniques described herein may be relevant for or associated with port and bridge management information exchange in 5GS. For example, port and bridge management information may be exchanged between the CNC entity and a TSN AF and the port management information may be related to Ethernet ports located in a DS-TT or an NW-TT. The 5GS may support a transfer of standardized and/or deployment-specific port management information transparently between the TSN AF and the DS-TT or the NW-TT, respectively inside a port management information container. The NW-TT may support one or more ports. In this case, each port may use a separate port management information container. The 5GS may also support transfer of standards and deployment-specific bridge management information transparently between the TSN AF and the NW-TT, respectively inside a bridge management information container. Table 1 and Table 2, shown below, detail some port management information and some bridge management information that may be associated with port management information and bridge management information exchanged in 5GS.

TABLE 1
Standardized Port Management Information

| | Applicability | | Supported | |
|---|---|---|---|---|
| | (see NOTE 6) | | operations | |
| | DS- | NW- | by TSN AF | |
| Port management information | TT | TT | (see NOTE 1) | Reference |
| General | | | | |
| Port management capabilities | X | X | R | |
| (see NOTE 2) | | | | |
| CNC TSN clock domain | X | | RW | |
| Bridge delay related information | | | | |
| txPropagationDelay (NOTE X1) | X | X | R | IEEE Std 802.1Qcc [95] |
| | | | | clause 12.32.2.1 |
| Traffic class related information | | | | |
| Traffic class table | X | X | RW | IEEE Std 802.1Q [98] |
| | | | | clause 12.6.3 and |
| | | | | clause 8.6.6. |
| Gate control information | | | | |
| GateEnabled | X | X | RW | IEEE Std 802.1Q [98] |
| | | | | Table 12-29 |
| AdminBaseTime (NOTE X2) | X | X | RW | IEEE Std 802.1Q [98] |
| | | | | Table 12-29 |
| AdminControlList (NOTE X2) | X | X | RW | IEEE Std 802.1Q [98] |
| | | | | Table 12-29 |
| AdminCycleTime (see NOTE 3 and | X | X | RW | IEEE Std 802.1Q [98] |
| NOTE X2) | | | | Table 12-29 |
| AdminControlListLength (see NOTE 3 | X | X | RW | IEEE Std 802.1Q [98] |
| and NOTE X2) | | | | Table 12-28 |
| Tick granularity | X | X | R | IEEE Std 802.1Q [98] |
| | | | | Table 12-29 |
| General Neighbor discovery | | | | |
| configuration (NOTE 4) | | | | |
| adminStatus | D | X | RW | IEEE Std 802.1AB [97] |
| | | | | clause 9.2.5.1 |
| lldpV2LocChassisIdSubtype | D | X | RW | IEEE Std 802.1AB [97] |
| | | | | Table 11-2 |
| lldpV2LocChassisId | D | X | RW | IEEE Std 802.1AB [97] |
| | | | | Table 11-2 |
| lldpV2MessageTxInterval | D | X | RW | IEEE Std 802.1AB [97] |
| | | | | Table 11-2 |
| lldpV2MessageTxHoldMultiplier | D | X | RW | IEEE Std 802.1AB [97] |
| | | | | Table 11-2 |
| NW-TT port neighbor discovery | | | | |
| configuration | | | | |
| lldpV2LocPortIdSubtype | | X | RW | IEEE Std 802.1AB [97] |
| | | | | Table 11-2 |
| lldpV2LocPortId | | X | RW | IEEE Std 802.1AB [97] |
| | | | | Table 11-2 |
| DS-TT port neighbor discovery | | | | |
| configuration | | | | |
| lldpV2LocPortIdSubtype | D | | RW | IEEE Std 802.1AB [97] |
| | | | | Table 11-2 |
| lldpV2LocPortId | D | | RW | IEEE Std 802.1AB [97] |
| | | | | Table 11-2 |
| Neighbor discovery information for | | | | |
| each discovered neighbor of NW-TT | | | | |
| lldpV2RemChassisIdSubtype | | X | R | IEEE Std 802.1AB [97] |
| | | | | Table 11-2 |
| lldpV2RemChassisId | | X | R | IEEE Std 802.1AB [97] |
| | | | | Table 11-2 |
| lldpV2RemPortIdSubtype | | X | R | IEEE Std 802.1AB [97] |
| | | | | Table 11-2 |
| lldpV2RemPortId | | X | R | IEEE Std 802.1AB [97] |
| | | | | Table 11-2 |
| TTL | | X | R | IEEE Std 802.1AB [97] |
| | | | | clause 8.5.4 |
| Neighbor discovery information for | | | | |
| each discovered neighbor of DS-TT | | | | |
| (NOTE 5) | | | | |
| lldpV2RemChassisIdSubtype | D | | R | IEEE Std 802.1AB [97] |
| | | | | Table 11-2 |
| lldpV2RemChassisId | D | | R | IEEE Std 802.1AB [97] |
| | | | | Table 11-2 |
| lldpV2RemPortIdSubtype | D | | R | IEEE Std 802.1AB [97] |
| | | | | Table 11-2 |
| lldpV2RemPortId | D | | R | IEEE Std 802.1AB [97] |
| | | | | Table 11-2 |
| TTL | D | | R | IEEE Std 802.1AB [97] |
| | | | | clause 8.5.4.1 |
| Stream Parameters (NOTE 11) | | | | |
| MaxStreamFilterInstances | X | | R | IEEE Std 802.1Q [98] |
| | | | | clause 12.31.1.1 |
| MaxStreamGateInstances | X | | R | IEEE Std 802.1Q [98] |
| | | | | clause 12.31.1.2 |
| MaxFlowMeterInstances | X | | R | IEEE Std 802.1Q [98] |
| | | | | clause 12.31.1.3 |
| SupportedListMax | X | | R | IEEE Std 802.1Q [98] |
| | | | | clause 12.31.1.4 |
| Per-Stream Filtering and Policing | | | | |
| information (NOTE 10) | | | | |
| Stream Filter Instance Table | | | | IEEE Std 802.1Q [98] |
| (NOTE 8) | | | | Table 12-32 |
| > StreamFilterInstanceIndex | X | X | RW | IEEE Std 802.1Q [98] |
| | | | | Table 12-32 |
| > Stream Identification type | X | X | RW | IEEE 802.1CB [83] |
| | | | | clause 9.1.1.6 |
| > Stream Identification | X | X | RW | IEEE 802.1CB [83] |
| Controlling Parameters | | | | clauses 9.1.2, 9.1.3, |
| | | | | 9.1.4 (NOTE 12) |
| > PrioritySpec | X | X | RW | IEEE Std 802.1Q [98] |
| | | | | Table 12-32 |
| > StreamGateInstanceID | X | X | RW | IEEE Std 802.1Q [98] |
| | | | | Table 12-32 |
| Stream Gate Instance Table | | | | IEEE Std 802.1Q [98] |
| (NOTE 9) | | | | Table 12-33 |
| StreamGateInstanceIndex | X | X | R | IEEE Std 802.1Q [98] |
| | | | | Table 12-33 |
| PSFP AdminBase Time (NOTE X3) | X | X | RW | IEEE Std 802.1Q [98] |
| | | | | Table 12-33 |
| PSFP AdminControlList (NOTE X3) | X | X | RW | IEEE Std 802.1Q [98] |
| | | | | Table 12-33 |
| PSFPAdminCycleTime (NOTE X3) | X | X | RW | IEEE Std 802.1Q [98] |
| | | | | Table 12-33 |
| PSFPTickGranularity | X | X | R | IEEE Std 802.1Q [98] |
| | | | | Table 12-33 |

(NOTE 1):
R = Read only access; RW = Read/Write access.
(NOTE 2):
Indicates which standardized and deployment-specific port management information is supported by DS-TT or NW-TT.
(NOTE 3):
AdminCycleTime and AdminControlListLength are optional for gate control information.
(NOTE 4):
If DS-TT supports neighbor discovery, then TSN AF sends the general neighbor discovery configuration for DS-TT Ethernet ports to DS-TT. If DS-TT does not support neighbor discovery, then TSN AF sends the general neighbor discovery configuration for DS-TT Ethernet ports to NW-TT using the Bridge Management Information Container (refer to Table 5.28.3.1-2) and NW-TT performs neighbor discovery on behalf on DS-TT. When a parameter in this group is changed, it is necessary to provide the change to every DS-TT and the NW-TT that belongs to the 5GS TSN bridge. It is mandatory that the general neighbor discovery configuration is identical for all DS-TTs and the NW-TTs that belongs to the bridge.
(NOTE 5):
If DS-TT supports neighbor discovery, then TSN AF retrieves neighbor discovery information for DS-TT Ethernet ports from DS-TT. If DS-TT does not support neighbor discovery, then TSN AF retrieves neighbor discovery information for DS-TT Ethernet ports from NW-TT, using the Bridge Management Information Container (refer to Table 5.28.3.1-2), the NW-TT performing neighbor discovery on behalf on DS-TT.
NOTE 6:
X = applicable; D = applicable when validation and generation of link layer discovery protocol (LLDP) frames is processed at the DS-TT.
NOTE 7:
Void.
(NOTE 8):
There is a Stream Filter Instance Table per Stream.
(NOTE 9):
There is a Stream Gate Instance Table per Gate.
(NOTE 10):
TSN AF indicates the support for PSFP to the CNC only if each DS-TT and NW-TT of the 5GS bridge has indicated support of PSFP. DS-TT indicates support of PSFP using port management capabilities, i.e., by indicating support for the Per-Stream Filtering and Policing information and by setting higher than zero values for MaxStreamFilterInstances, MaxStreamGateInstances, MaxFlowMeterInstances, SupportedListMax parameters. When available, TSN AF uses the PSFP information for determination of the traffic pattern information as described in Annex I. The PSFP information can be used at the DS-TT (if supported) and at the NW-TT (if supported) for the purpose of per-stream filtering and policing as defined in IEEE Std 802.1Q [98] clause 8.6.5.1.
(NOTE 11):
TSN AF composes a Stream Parameter Table towards the CNC. It is up to TSN AF how it composes the Stream Parameter Table based on the numerical values as received from DS-TT and NW-TT port(s) and for the bridge for each individual parameter.
NOTE 12:
The set of Stream Identification Controlling Parameters depends on the Stream Identification type value as defined in IEEE Std 802.1CB [83] Table 9-1 and clauses 9.1.2, 9.1.3, 9.1.4.
(NOTE X1):
If DS-TT received CNC TSN clock domain information from TSN AF, then DS-TT shall map the measured propagation delay from the 5G clock to the CNC's TSN clock based on the cumulative rateRatio between the 5G clock and the CNC's TSN clock before providing it as txPropagationDelay to the TSN AF. If NW-TT is preconfigured with CNC TSN clock domain information, then NW-TT shall map the measured propagation delay from the 5G clock to the CNC's TSN clock based on the cumulative rateRatio between the 5G clock and the CNC's TSN clock before providing it as txPropagationDelay to the TSN AF.
(NOTE X2):
TSN AF maps the AdminBaseTime received from the CNC from the CNC's TSN clock to the 5G clock before signaling AdminBaseTime to DS-TT and NW-TT. If DS-TT receives the CNC's TSN clock domain information using port management information from TSN AF, then DS-TT shall locally map the received AdminControlList and AdminCycleTime from the CNC's TSN clock to the5G clock based on the cumulative rateRatio (as received from the NW-TT) between the CNC's TSN time and 5GS time. If the NW-TT is preconfigured with the CNC's TSN clock domain information then NW-TT shall locally map the received AdminControlList and AdminCycleTime from the CNC's TSN clock to the5G clock based on the cumulative rateRatio (as received from the NW-TT) between the CNC's TSN time and 5GS time.
(NOTE X3):
TSN AF maps the PSFPAdminBaseTime received from the CNC from the CNC's TSN clock to the 5G clock before signaling PSFP AdminBaseTime to DS-TT and NW-TT. If DS-TT also received the CNC's TSN clock domain information, then DS-TT shall locally map the received PSFP AdminControlList, PSFP AdminBaseTime and PSFPAdminCycleTime from the CNC's TSN clock to the 5G clock based on the time offset and cumulative rateRatio between the CNC's TSN time and 5GS time. If the NW-TT is preconfigured with the CNC's TSN clock domain information then NW-TT shall locally map the received PSFP AdminControlList, PSFP AdminBaseTime and PSFPAdminCycleTime from the CNC's TSN clock to the 5G clock based on the time offset and cumulative rateRatio between the CNC's TSN time and 5GS time.

TABLE 2
Standardized Bridge Management Information

| | Supported | |
|---|---|---|
| | operations | |
| | by TSN AF | |
| Bridge management information | (see NOTE 1) | Reference |
| Information for 5GS Bridge | | |
| Bridge Address | R | |
| Bridge ID | R | |
| NW-TT port numbers | R | |
| Traffic forwarding information | | |
| Static Filtering Entry (NOTE 3) | RW | IEEE Std 802.1Q [98] |
| | | clause 8.8.1 |
| General Neighbor discovery | | |
| configuration (NOTE 2) | | |
| adminStatus | RW | IEEE Std 802.1AB [97] |
| | | clause 9.2.5.1 |
| lldpV2LocChassisIdSubtype | RW | IEEE Std 802.1AB [97] |
| | | Table 11-2 |
| lldpV2LocChassisId | RW | IEEE Std 802.1AB [97] |
| | | Table 11-2 |
| lldpV2MessageTxInterval | RW | IEEE Std 802.1AB [97] |
| | | Table 11-2 |
| lldpV2MessageTxHoldMultiplier | RW | IEEE Std 802.1AB [97] |
| | | Table 11-2 |
| DS-TT port neighbor discovery | | |
| configuration for DS-TT ports (NOTE 4) | | |
| >DS-TT port neighbor discovery | | |
| configuration for each DS-TT port | | |
| >> DS-TT port number | RW | |
| >> lldpV2LocPortIdSubtype | RW | IEEE Std 802.1AB [97] |
| | | Table 11-2 |
| >> lldpV2LocPortId | RW | IEEE Std 802.1AB [97] |
| | | Table 11-2 |
| Discovered neighbor information for | | |
| DS-TT ports (NOTE 4) | | |
| >Discovered neighbor information for | | |
| each DS-TT port (NOTE 4) | | |
| >> DS-TT port number | R | |
| >> lldpV2RemChassisIdSubtype | R | IEEE Std 802.1AB [97] |
| | | Table 11-2 |
| >> lldpV2RemChassisId | R | IEEE Std 802.1AB [97] |
| | | Table 11-2 |
| >> lldpV2RemPortIdSubtype | R | IEEE Std 802.1AB [97] |
| | | Table 11-2 |
| >> lldpV2RemPortId | R | IEEE Std 802.1AB [97] |
| | | Table 11-2 |
| >> TTL | R | IEEE Std 802.1AB [97] |
| | | clause 8.5.4.1 |
| Stream Parameters (NOTE 5) | | |
| MaxStreamFilterInstances | R | IEEE Std 802.1Q [98] |
| MaxStreamGateInstances | R | IEEE Std 802.1Q [98] |
| MaxFlowMeterInstances | R | IEEE Std 802.1Q [98] |
| SupportedListMax | R | IEEE Std 802.1Q [98] |

(NOTE 1):
R = Read only access; RW = Read/Write access.
(NOTE 2):
General neighbor discovery information is included only when NW-TT performs neighbor discovery on behalf of DS-TT. When a parameter in this group is changed, it is necessary to provide the change to every DS-TT and the NW-TT that belongs to the 5GS TSN bridge.
(NOTE 3):
If the Static Filtering Entry information is present, NW-TT uses Static Filtering Entry information to determine the NW-TT egress port for forwarding UL TSC traffic. If the Static Filtering Entry information is not present, then the forwarding information as in clause 5.8.2.5.3 applies. This release of the specification does not support Static Filtering Entries in the downlink direction.
(NOTE 4):
DS-TT discovery configuration and DS-TT discovery information are used only when DS-TT does not support LLDP and NW-TT performs neighbor discovery on behalf of DS-TT.
(NOTE 5):
TSN AF indicates the support for PSFP to the CNC only if each DS-TT and NW-TT of the 5GS bridge have indicated support of PSFP. The support of PSFP at the NW-TT ports is expressed by setting higher than zero values for MaxStreamFilterInstances, MaxStreamGateInstances, MaxFlowMeterInstances, SupportedListMax parameters.

In some examples, an exchange of port and bridge management information between a TSN AF and an NW-TT or a DS-TT may allow the TSN AF to retrieve port management information for a DS-TT or an NW-TT Ethernet port or bridge management information for a 5GS TSN bridge, send port management information for a DS-TT or an NW-TT Ethernet port or bridge management information for a 5GS TSN bridge, or subscribe to and receive notifications if specific port management information for a DS-TT or an NW-TT Ethernet port changes or bridge management information changes, or any combination thereof.

An exchange of port management information between a TSN AF and an NW-TT or a DS-TT may be initiated by the DS-TT or the NW-TT to notify the TSN AF if port management information has changed that the TSN AF has subscribed for. An exchange of bridge management information between a TSN AF and an NW-TT may be initiated by the NW-TT to notify TSN AF if bridge management information has changed that TSN AF has subscribed for. An exchange of port management information may be initiated by a DS-TT to provide port management capabilities, such as to provide information indicating which standardized and deployment-specific port management information is supported by the DS-TT. Further, the TSN AF ma indicate inside the port management information container or the bridge management information container whether the TSN AF is configured to (e.g., wants to) retrieve or send port or bridge management information or intends to (un-)subscribe for notifications.

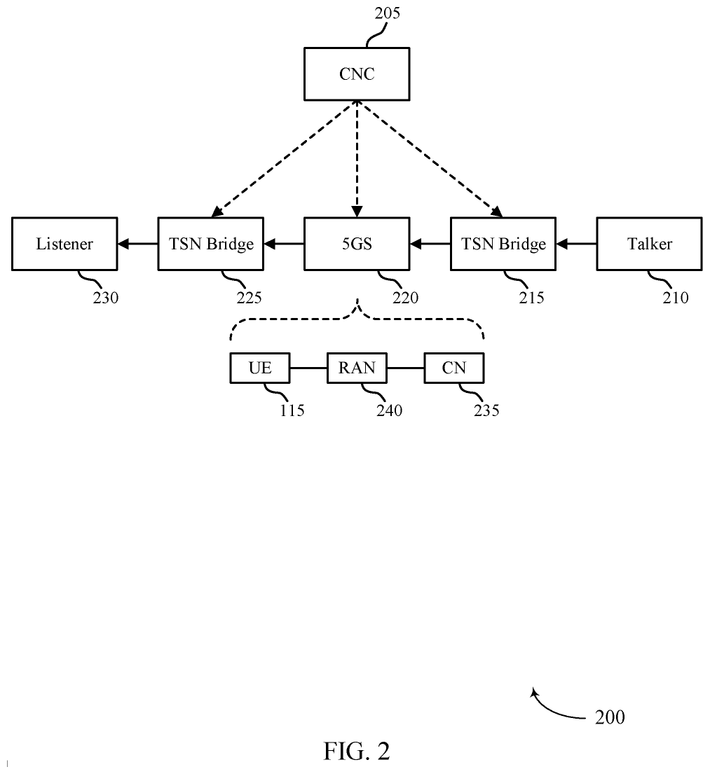

FIG. 2 illustrates an example of a TSN system 200 that supports TSN support in a 5GS in accordance with aspects of the present disclosure. The TSN system 200 may implement or be implemented to realize aspects of the wireless communications system 100 or may interface with one or more components of the wireless communications system 100. For example, the TSN system 200 illustrates a flow of data from a talker 210 to a listener 230 via one or more bridges and one of the bridges may be a wireless communications system, such as a 5GS 220 including one or more of a core network 235, a radio access network (RAN) or RAN 240, or a UE 115. In some examples, a network entity of the 5GS 220 may perform a mapping between a first clock used by the TSN system 200 (e.g., by a CNC entity 205 of the TSN system 200) and a second clock used by the 5GS 220 to achieve time synchronization with other components of the TSN system 200.

For example, the CNC entity 205 may provide timing control information (e.g., gate scheduling information, filtering and policing control information, etc.) to each bridge between the talker 210 and the listener 230 to control the flow of data between the talker 210 (e.g., a sender of data packets or frames) and the listener 230 (e.g., a receiver of the data packets or frames). The CNC entity 205 may schedule the transfer or flow of data between the components of the TSN system 200 such that traffic patterns are fixed and predictable. For example, some industrial automation scenarios may be based on cyclic traffic patterns (e.g., controllers may regularly send control commands to actuators, such as a robot arm) and preserving the traffic pattern may increase the likelihood for successful communication and performance. In other words, some deployment scenarios may be associated with a strict traffic schedules and may be sensitive to traffic delays. For example, if commands reach an actuator too late, the actuator (e.g., a robot arm) may act too late, which may result in manufacturing errors (e.g., a dent in a surface being manufactured, a misplaced welding spot, etc.).

Ethernet networks with enhancements to reduce delay and jitter may be used for some industrial automation scenarios and may provide short cycle times with bounded jitter. In addition to or as an alternative to such Ethernet networks, one or more devices may implement TSN to bound latency or jitter, or both, and to avoid frame loss due to congestion in some Ethernet networks, such as switched Ethernet networks (e.g., including wired switches). In some deployments, TSN may serve as a common Layer 2 mechanism for time-sensitive traffic for industrial automation and other domains. As part of TSN, a TSN switch may employ a time-triggered forwarding process according to which the TSN switch receives traffic at one or ingress ports, selects an egress port based on a destination medium access control (MAC) address, selects a traffic class based on a priority field in a virtual local area network (VLAN) header, and open gates for each of the different traffic classes in a predictable or cyclic manner. In some aspects, the opening of the gates for the different traffic classes may be in accordance with gate schedules or time-based transmission schedules (and may be configured by the CNC entity 205).

Further, in some examples, TSN may be integrated with or implemented for a 5GS (e.g., to allow factory networks to use wireless communication, such as 5G, instead of or in addition to wired networks that may use fiber or copper). As shown in FIG. 2, the bridges between the talker 210 and the listener 230 may include a TSN bridge 215, the 5GS 220, and a TSN bridge 225 and the CNC entity 205 may provide control commands to each of the TSN bridge 215, the 5GS 220, and the TSN bridge 225. Such control commands may include bridge management commands, which may include retrieving bridge capabilities from each bridge and providing timing control information, such as gate schedules, to each bridge. In some examples, the CNC entity 205 may calculate the gate schedule for the TSN bridges based on constraints associated with the talker 210 and the listener 230. Accordingly, each bridge may execute functions or operate in accordance with the bridge management commands received from the CNC entity 205.

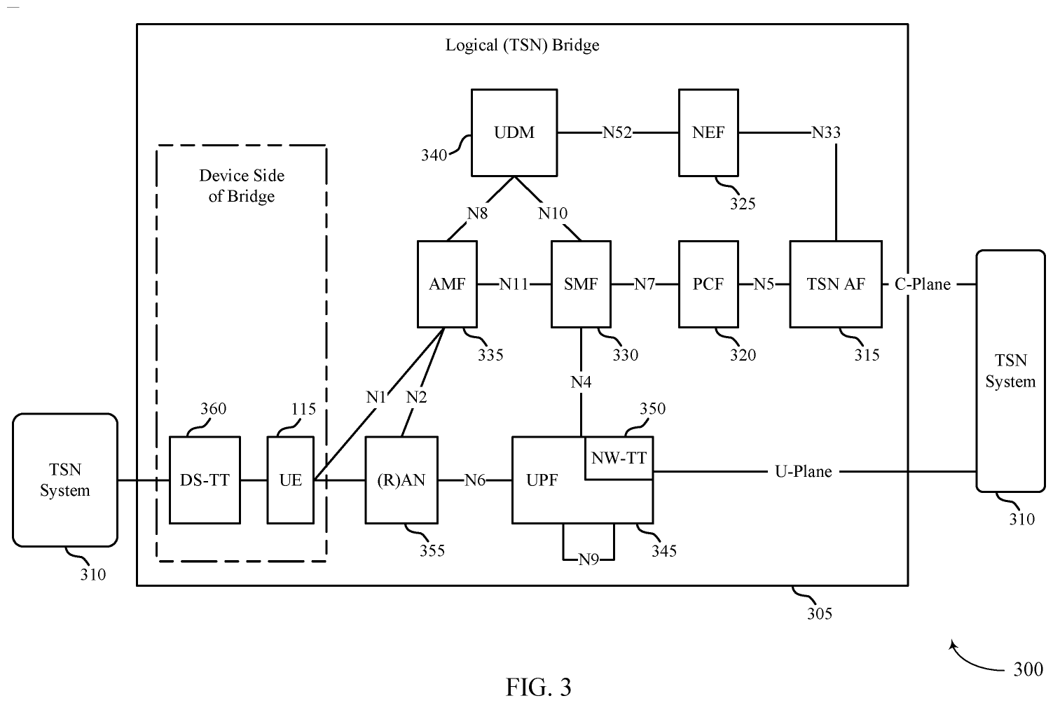

As a result of each of the TSN bridges operating according to the configured gate schedule, communication errors or inefficiencies may occur if one of the bridges has a different understanding of time. For example, if the 5GS 220 has a different concept of time (e.g., uses a different clock) than one or more other components of the TSN system 200 (e.g., the CNC entity 205, the TSN bridge 215, or the TSN bridge 225), one or more components of the 5GS 220 may open gates for traffic at times that are out of sync with the traffic flow expected by one or both of the TSN bridge 215 or the TSN bridge 225, which may result in communication failures or the loss of some data packets. Additional details relating to such issues that may arise from the 5GS 220 using a different clock are described herein, including with reference to FIG. 3.

In such examples in which the 5GS 220 use a different clock than the CNC entity 205, a network entity of the 5GS 220 (e.g., a network entity associated with one or more of the core network 235, the RAN 240, or the UE 115) may perform a mapping between the different clocks such that the 5GS 220 is able to achieve time synchronization with the TSN bridge 215 and the TSN bridge 225. Such time synchronization may include a forwarding of data packets received from the TSN bridge 215 to the TSN bridge 225 in accordance with a commonly understood gate schedule regardless of which clock domain the CNC entity 205 uses to provide the timing commands for the gate schedule. Additional details relating to such a mapping operation are described herein, including with reference to FIGS. 3 through 5.

FIG. 3 illustrates an example of a bridge interface 300 that supports TSN support in a 5GS in accordance with aspects of the present disclosure. The bridge interface 300 may illustrate an interface between a logical bridge 305 (which may be an example of a 5GS bridge, such as the 5GS 220 as described with reference to FIG. 2) and a TSN system 310 (which may be an example of the TSN system 200, as described with reference to FIG. 2). In some examples, a network entity of the logical bridge 305 may perform a mapping between a first clock used by the TSN system 310 and a second clock used by the network entity and may communicate with one or more components of the TSN system 310 based on the timing control information and performing the mapping.

The logical bridge 305, which may be equivalently referred to herein as a logical TSN bridge, may include components or entities associated with a core network, a RAN, and a device side (e.g., a UE 115 side). For example, the logical bridge 305 may include a TSN AF 315, a policy control function (PCF) 320, a network exposure function (NEF) 325, an SMF 330, an access and mobility management function (AMF) 335, a unified data management (UDM) 340, a UPF 345, an NW-TT 350, a RAN 335 (which may equivalently be any access network), a UE 115, and a DS-TT 360. The TSN AF 315 may communicate with the TSN system 310 (e.g., with a CNC entity of the TSN system 310) via a control-plane (C-plane) interface and the NW-TT 350 may communicate with the TSN system 310 (e.g., a TSN bridge or a next hop neighbor of the TSN system 310) via a user-plane (U-plane) interface. The DS-TT 360 may similarly communicate with another TSN bridge or another next hop neighbor of the TSN system 310. The components or entities of the logical bridge 305 may communicate with each other via one or more interfaces or links, as illustrated by FIG. 3.

To support TSN in a 5GS, communicating components may share several timing-related aspects for efficient and reliable scheduling. For example, a network entity of the 5GS may report minimum delay or a maximum delay or both that the 5GS (if functioning as a TSN bridge) is able to support and may report a propagation delay. Such a propagation delay may refer to a delay between an Ethernet port in the DS-TT 360 or the NW-TT 350 of the logical bridge 305 (e.g., the 5GS bridge) and a next hop Ethernet station connection to that Ethernet port. To enable the reporting of such a propagation delay, the DS-TT 360 or the NW-TT 350, or both, may measure the propagation delay to their next hop neighbor for each Ethernet port and may report the measured propagation delay to the TSN AF 315. The TSN AF 315 may report the propagation delay for each (e.g., every) Ethernet port on any DS-TT 360 or NW-TT 350 to the CNC entity of the TSN system 310.

The logical bridge 305 may also support scheduled traffic, which the logical bridge 305 may enable as a result of using a hold and forward buffer in the DS-TT 360 or the NW-TT 350, or both. The CNC entity may provide transmission gate control information to the logical bridge 305 (e.g., to the DS-TT 360 or the NW-TT 350, or both) to indicate when and for how long the DS-TT 360 or the NW-TT 350, or both, is to hold frames in the buffer. For example, the CNC entity may send the transmission gate control information to the TSN AF 315 and the TSN AF 315 may forward the transmission gate control information to the DS-TTs 360 and the NW-TTs 350. The transmission gate control information may indicate, to the DS-TT 360 and the NW-TT 350, when to open different gates of queues for different Ethernet traffic classes, as described in more detail herein, including with reference to FIG. 2.

The logical bridge 305 may also support per-stream filtering and policing (PSFP) by an optional filtering and policing functionality in the DS-TT 360 or the NW-TT 350. Such filtering and policing may refer to a dropping of one or more frames and the logical bridge 305 (e.g., the DS-TT 360 or the NW-TT 350) may receive PSFP control information from the CNC entity indicating which frames to drop. For example, the CNC entity may send PSFP control information to the TSN AF 315 and the TSN AF 315 may forward the PSFP control information to the DS-TTs 360 and the NW-TTs 350. The PSFP control information may indicate, to the DS-TT 360 and the NW-TT 350, when to accept frames of a specific flow (e.g., at which time to accept frames of a specific flow). Accordingly, the DS-TT 360 and the NW-TT 350 may drop frames that arrive outside of the time windows indicated by the PSFP control information.

In some examples, the effectiveness of the TSN system 310 may rely on a common sense of time (e.g., a common clock or synchronized clock) between the logical bridge 305 (e.g., a 5GS bridge) and TSN system 310. For example, if the logical bridge 305 (or one or more components or network entities of the logical bridge 305) uses a different reference clock than the TSN system 310 (e.g., the CNC entity), the timing control information that is shared between the logical bridge 305 and the TSN system 310 may be interpreted differently at each network location, which may result in differing understandings of when to accept frames of specific flows and of when to transmit frames of specific flows. Such difference in concepts of time may result in a higher likelihood for communication failures and greater latency.

For example, the CNC entity may calculate or otherwise determine transmission gate and PSFP control information (which may be collectively referred to herein as control information or timing control information) using (e.g., in reference to) a first clock, but the logical bridge 305 (e.g., the 5GS and, likewise, the DS-TT 360 and the NW-TT 350) may use or reference a second clock (e.g., a 5G clock) different from the first clock. In some examples, for instance, the DS-TT 360 and the NW-TT 350 may operate based on the second clock and devices within the 5GS may use a global navigation satellite system (GNSS) receiver to time synchronize RAN nodes to the second clock whereas the CNC entity may use the first clock, which may not be synchronized to an external time source. For example, the CNC entity may operate in a factory and the first clock used by the CNC entity may be deployed separate than a wireless network (such as 5GS) being installed in the factory.

As a result of using a different clock than the first clock used by the CNC entity, the DS-TT 360 and the NW-TT 350 may interpret the timing control information received from the CNC entity differently than intended by the CNC entity and may operate their respective gates according to a potentially different gate schedule than other components of the TSN system 310 (e.g., other TSN bridges). For example, the transmission gate control information may include an AdminBaseTime parameter, which may indicate a reference time for gate schedules (e.g., gate schedules are specified as times relative to AdminBaseTime). If the 5GS and the CNC entity use different clocks, there may be an offset between the different clocks and the different clocks may drift further apart (in the time domain). As such, to ensure correct interpretation of the gate schedule, the DS-TT 360 and the NW-TT 350 may interpret the AdminBaseTime in reference to the TSN clock or convert the AdminBaseTime into 5GS time. In some systems, however, the DS-TT 360 and the NW-TT 350 may lack a configuration to be aware of the TSN clock or to perform such a conversion.

Further, the frequencies (e.g., clock ticks per unit time, such as second) of the 5GS clock and the TSN clock may differ. As such, to ensure correct operation, the DS-TT 360 and the NW-TT 350 may correct an AdminCycleTime in accordance with the frequency differences between the 5GS clock and the TSN clock. Otherwise, the transmission gate schedule cycle may be shorter or longer compared to the intended duration (e.g., as intended by the CNC entity), which may lead to an incorrect enforcement of the transmission gate schedules.

Additionally or alternatively, the difference in the clocks used by the 5GS and the CNC entity may result in incorrect interpretation of the reported propagation delays measured at the logical bridge 305 (e.g., at one or more network entities of the logical bridge 305. For example, the DS-TT 360 and the NW-TT 350 may synchronize to the 5GS clock and may measure the propagation delay to their next hop neighbor using the 5GS clock as a reference. In some systems, the DS-TT 360 and the NW-TT 350 may signal the measured propagation delays “as-is” from the 5GS to the CNC entity, which may result in a mis-interpretation of the propagation delays at the CNC entity (e.g., as the CNC entity may interpret the propagation delays using the TSN clock instead of the 5GS clock according which the propagation delays were measured). This may result in issues if the frequencies of the clocks (e.g., the number of “ticks” per second) used by the 5GS clock and the CNC clock deviate. If so, for example, the measured propagation delays may appear to the CNC entity shorter or longer than they actually are. As a result of such incorrect interpretation of the propagation delays, the CNC entity may plan end-to-end flows incorrectly, which may lead to frames reaching intermediate switches too early or too late, which may in turn break the end-to-end TSN mechanism.

In some implementations, the logical bridge 305 (or a network entity of the logical bridge 305) may perform a mapping between the first clock (e.g., the TSN clock) used by the CNC entity and the second clock (e.g., the 5GS clock) used by the logical bridge 305 to support the correct interpretation of timing control information and propagation delay measurements that are signaled between the CNC entity and the logical bridge 305. The logical bridge 305 may perform the mapping via the DS-TT 360 or the NW-TT 350 or via the TSN AF 315 and, in some examples, the operations or signaling mechanisms that the logical bridge supports to facilitate the mapping may vary depending on which of the DS-TT 360, the NW-TT 350, or the TSN AF 315 perform the mapping.

In implementations in which the DS-TT 360 or the NW-TT 350 locally map the TSN control information between first time (e.g., CNC time) and second time (e.g., 5GS time), the DS-TT 360 or the NW-TT 350 may select, obtain, or otherwise determine a clock domain number corresponding to the TSN clock used by the CNC entity and the DS-TT 360 or the NW-TT 350 may calculate the current time of the TSN clock identified by the received domain number. For example, the DS-TT 360 or the NW-TT 350 may receive (e.g., via an Ethernet broadcast) one or more synchronization messages, such as precision timing control (PTP) messages or generic PTP (gPTP) messages, including the clock domain number corresponding to the TSN clock and the DS-TT 360 or the NW-TT 350 may process (for gate schedule information) the one or more synchronization messages based on the selected, obtained, or otherwise determined clock domain number corresponding to the TSN clock.

In some examples, the NW-TT 350 may receive such synchronization messages from the TSN system 310 and may transmit the synchronization messages to the DS-TT 360. In such examples, the DS-TT 360 or the NW-TT 350 may calculate the current time of the TSN clock based on the synchronization messages including the clock domain number of a residence time of a synchronization message within the 5GS (e.g., the time that the synchronization message spends between the NW-TT 350 and the DS-TT 360). The NW-TT 350 may apply an ingress time stamp (e.g., to an originTimestamp field in the synchronization message) and the synchronization message or a follow-up message may include a correction field, and the DS-TT 360 or the NW-TT 350 may calculate the residence time based on the ingress time stamp applied by the NW-TT 350 and the current time in the DS-TT 360.

As a result of calculating the current time of the TSN clock, the DS-TT 360 or the NW-TT 350 may calculate a clock drift between the 5GS clock and the TSN clock (e.g., a delta calculated by 5GS time minus TSN time) or may calculate a cumulative rate ratio between the 5GS clock and the TSN clock (e.g., a ratio of the frequency difference between the two clocks), or may calculate both. The DS-TT 360 or the NW-TT 350 may calculate or extract the cumulative rate ratio from synchronization messages or follow-up messages received from the NW-TT 350 (which may also include the clock domain number corresponding to the TSN clock used by the CNC entity).

As such, the DS-TT 360 or the NW-TT 350 may convert received timing control information (e.g., transmission gate and PSFP control information) from TSN time into 5GS time by mapping absolute times (e.g., AdminBaseTime) from TSN time to 5GS time as a result of applying the calculated clock drift (e.g., the delta) and by converting time durations (e.g., AdminCycleTime) from the TSN clock to the 5GS clock as a result of applying the cumulative rate ratio between the two clocks. Similarly, the DS-TT 360 or the NW-TT 350 may convert the measured propagation delay to the next hop neighbor from the 5GS clock to the TSN clock as a result of applying the cumulative rate ratio between the 5GS clock and the TSN clock. In some examples, the DS-TT 360 or the NW-TT 350 may convert the measured propagation delay and may transmit the converted or corrected propagation delay to the TSN AF 315, which may forward to the CNC entity.

The DS-TT 360 or the NW-TT 350 may select, obtain, or otherwise determine the clock domain number corresponding to the TSN clock used by the CNC entity in various ways. In some examples, the TSN AF 315 may be preconfigured with the clock domain number (which may be identified via a domain number, such as an integer) used by the CNC entity and the TSN AF 315 may indicate the clock domain number to the DS-TT 360 or the NW-TT 350. In some other examples, the TSN AF 315 may refrain from indicating the clock domain number to the DS-TT 360 or the NW-TT 350 and, instead, the DS-TT 360 or the NW-TT 350 may assume or expect that the TSN clock used by the CNC entity uses a specific clock domain (e.g., domain 0). For example, the clock domain number may be pre-configured at the DS-TT 360 or the NW-TT 350 and the DS-TT 360 or the NW-TT 350 may use the pre-configured clock domain number to calculate the current time of the TSN clock. Such a pre-configuration or assumption of the clock domain number at the DS-TT 360 or the NW-TT 350 may be feasible in some scenarios because some TSN deployments sometimes (e.g., relatively frequently) use a same clock domain number (e.g., the clock domain number 0). The assumption that the DS-TT 360 or the NW-TT 350 makes for the clock domain number may be left to device-decision or implementation or may be specified by a standard.

In implementations in which the TSN AF 315 maps TSN control information between the TSN time used by the first time (e.g., CNC entity) and the second time (e.g., 5GS time), the TSN AF 315 may be pre-configured with the clock domain number corresponding to the TSN clock used by the CNC entity and may subscribe for receiving clock drift and cumulative rate ratio information from one or both of the SMF 330 or the UPF 345 (via the PCF 320) for that clock domain number. For example, the UPF 345 may track or calculate clock drift and cumulative rate ratio information between the TSN clock and the 5GS clock for one or more clock domain numbers and may transmit such information to the SMF 330. Accordingly, the TSN AF 315 may transmit a request for the clock drift and cumulative rate ratio information to the SMF 330 via the PCF 320 and, responsive to the request, may receive the information from the SMF 330. In some examples, the TSN AF 315 may include an indication of the clock domain number corresponding to the TSN clock used by the CNC entity in the request to enable the SMF 330 to provide the relevant information responsive to the request.

As a result of receiving the clock drift and cumulative rate ratio information from the SMF 330, the TSN AF 315 may map the timing control information (e.g., the transmission gate and PSFP control information) received from the CNC entity from TSN time to 5GS time by mapping absolute times (e.g., AdminBaseTime) from TSN time to 5GS time as a result of applying the received clock drift and by converting time durations (e.g., AdminCycleTime) from the TSN clock to the 5GS clock as a result of applying the received cumulative rate ratio. As such, the TSN AF 315 may relay converted or mapped timing control information to the DS-TT 360 and the NW-TT 350. Similarly, the TSN AF 315 may map the propagation delay measured by and received from the DS-TT 360 or the NW-TT 350 from the 5GS clock to the TSN clock as a result of applying the received cumulative rate ratio and may send the converted or mapped propagation delay to the CNC entity.

In some examples, the clock drift or the cumulative rate ratio between the TSN clock and the 5GS clock may change over time and the SMF 330 may provide the TSN AF 315 with updated clock drift information or updated cumulative rate ratio information, or both. In such examples in which the TSN AF 315 receives updated clock drift information or updated cumulative rate ratio information, or both, the TSN AF 315 may perform an updated mapping between the TSN clock and the 5GS clock and may send updated timing control information (e.g., updated transmission gate and PSFP control information) to the DS-TT 360 and the NW-TT 350. Similarly, the TSN AF 315 may send updated propagation delay measurements to the CNC entity based on performing the updated mapping.

According to the implementations described herein, if the DS-TT 360 receives CNC TSN clock domain information from the TSN AF 315, the DS-TT 360 may map the measured propagation delay from the 5GS clock to the CNC's TSN clock based on the cumulative rate ratio between the 5GS clock and the CNC's TSN clock prior to providing the measured propagation delay as txPropagationDelay to the TSN AF 315. If the NW-TT 350 is pre-configured with the CNC TSN clock domain information, the NW-TT 350 may map the measured propagation delay from the 5GS clock to the CNC's TSN clock based on the cumulative rate ratio between the 5GS clock and the CNC's TSN clock prior to providing the measured propagation delay as txPropagationDelay to the TSN AF 315.

Further, the TSN AF 315 may map the AdminBaseTime received from the CNC entity from the CNC's TSN clock to the 5GS clock prior to signaling AdminBaseTime to the DS-TT 360 or the NW-TT 350. If the DS-TT 360 receives the CNC's TSN clock domain information using port management information from the TSN AF 315, the DS-TT 360 may locally map the received AdminControlList and AdminCycleTime from the CNC's TSN clock to the 5GS clock based on the cumulative rate ratio (e.g., as received from the NW-TT 350) between the CNC's TSN time and the 5GS time. If the NW-TT 350 is pre-configured with the CNC's TSN clock domain information, the NW-TT 350 may locally map the received AdminControlList and AdminCycleTime from the CNC's TSN clock to the 5GS clock based on the cumulative rate ratio (e.g., as received from the NW-TT 350) between the CNC's TSN time and the 5GS time.

Further, the TSN AF 315 may map the PSFPAdminBaseTime received from the CNC entity from the CNC's TSN clock to the 5GS clock prior to signaling the PSFPAdminBaseTime to the DS-TT 360 and the NW-TT 350. If the DS-TT 360 also receives the CNC's TSN clock domain information, the DS-TT 360 may locally map the received PSFPAdminControlList, the PSFPAdminBaseTime, and the PSFPAdminCycleTime from the CNC's TSN clock to the 5GS clock based on the time offset and the cumulative rate ratio between the CNC's TSN time and the 5GS time. If the NW-TT 350 is pre-configured with the CNC's TSN clock domain information, the NW-TT 350 may locally map the received PSFPAdminControlList, the PSFPAdminBaseTime, and the PSFPAdminCycleTime from the CNC's TSN clock to the 5GS clock based on the time offset and the cumulative rate ratio between the CNC's TSN time and the 5GS time.

As such, the logical bridge 305, or one or more components or entities of the logical bridge 305, may provide a mechanism for converting timing information that is shared between the logical bridge 305 (e.g., a 5GS bridge) that references a 5GS clock and the CNC entity that references a TSN clock, which may increase the likelihood that the logical bridge 305 and the TSN system 310 (or one or more components of the TSN system 310) are aligned in terms of gate schedules. Such an alignment of gate schedules between the logical bridge 305 (which may feature some wireless communication links) and the TSN system 310 (which may feature primarily wired communication links) may provide for greater deployment flexibility, higher data rates, and improved performance for some application scenarios (e.g., such as industrial automation applications).

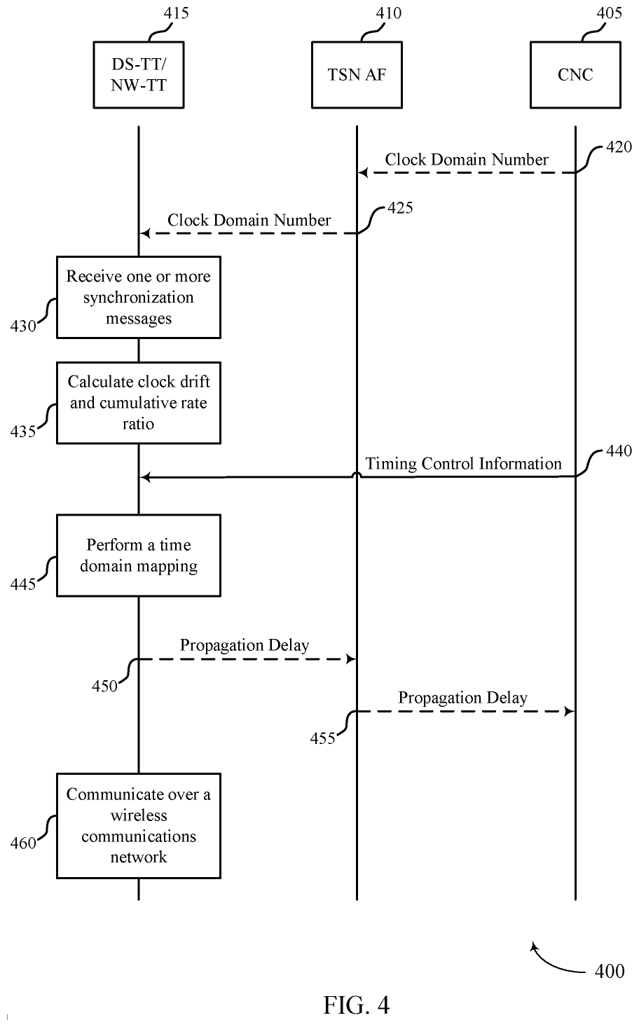

FIG. 4 illustrates an example of a process flow 400 that supports TSN support in a 5GS in accordance with aspects of the present disclosure. The process flow 400 may implement or be implemented to realize aspects of the wireless communications system 100, the TSN system 200, or the bridge interface 300. For example, the process flow 400 illustrates communication between a CNC entity 405 and a network entity including a TSN AF 410 and a DS-TT/NW-TT 415 (which may be an example of one or both of a DS-TT or an NW-TT), which may be examples of corresponding devices described herein, including with reference to FIGS. 1 through 3. In some examples, the network entity may perform, using the DS-TT/NW-TT 415, a time domain mapping between a first clock (e.g., a TSN clock) used by the CNC entity 405 and a second clock (e.g., a 5GS clock) used by the network entity.

In the following description of the process flow 400, the operations may be performed (such as reported or provided) in a different order than the order shown, or the operations performed by the example devices may be performed in different orders or at different times. Some operations also may be left out of the process flow 400, or other operations may be added to the process flow 400. Further, although some operations or signaling may be shown to occur at different times for discussion purposes, these operations may actually occur at the same time.

At 420, the TSN AF 410 may, in some implementations, receive an indication of a clock domain number from the CNC entity 405 corresponding to the first clock used by the CNC entity 405. Additionally or alternatively, the TSN AF 410 may be pre-configured with the clock domain number corresponding to the first clock used by the CNC entity 405. In some other implementations, the TSN AF 410 may be unaware of the clock domain number corresponding to the first clock used by the CNC entity.

At 425, the DS-TT/NW-TT 415 may, in some implementations, receive an indication of the clock domain number from the TSN AF 410 corresponding to the first clock used by the CNC entity 405. Additionally or alternatively, the DS-TT/NW-TT 415 may be pre-configured with or use an assumption of the clock domain number corresponding to the first clock used by CNC entity 405.

At 430, the DS-TT/NW-TT 415 may receive, from a TSN clock manager (e.g., a TSN grandmaster (TSN GM) clock), one or more messages (e.g., synchronization messages) indicating the first clock used by the CNC entity 405. For example, the DS-TT/NW-TT 415 may receive one or more synchronization messages, such as PTP or gPTP messages, including or containing the clock domain number corresponding to the first clock used by the CNC entity 405 and the DS-TT/NW-TT 415 may process the one or more synchronization messages using the received, pre-configured, or assumed clock domain number. In some examples, the DS-TT/NW-TT 415 may calculate a current clock time of the first clock as a result of processing the one or more synchronization messages using the received, pre-configured, or assumed clock domain number.

At 435, the DS-TT/NW-TT 415 may calculate a clock drift and a cumulative rate ratio between the first clock used by the CNC entity 405 and the second clock used by the network entity. In some examples, the DS-TT/NW-TT 415 may calculate the clock drift and the cumulative rate ratio using the one or more synchronization messages that include the clock domain number corresponding to the first clock used by the CNC entity 405 and by referencing the second clock used by the network entity. Additional details relating to such a calculation of the clock drift and the cumulative rate ratio between the first clock and the second clock are described herein, including with reference to FIG. 3.

At 440, the DS-TT/NW-TT 415 may receive, from the CNC entity (and via the TSN AF 410, timing control information. The timing control information may include transmission gate control information or PSFP control information, or both, and the CNC entity 405 may provide such control information to configure a gate schedule between a talker and a listener via one or more bridges (including a bridge provided by the network entity). In some examples, the timing control information may include or be referred to as gate schedule timing information (which may include or refer to an absolute value of a time instance) and gate schedule cycle information (which may include or refer to a time duration).

At 445, the DS-TT/NW-TT 415 may perform a time domain mapping between the first clock used by the CNC entity 405 and the second clock used by the network entity. For example, the DS-TT/NW-TT 415 may map the gate schedule timing information from the first clock used by the CNC entity 405 to the second clock used by the network entity based on the clock drift between the first clock and the second clock. Additionally or alternatively, the DS-TT/NW-TT 415 may map the gate schedule cycle information from the first clock used by the CNC entity 405 to the second clock used by the network entity based on the cumulative rate ratio between the first clock and the second clock. Additionally or alternatively, the DS-TT/NW-TT 415 may map a measured propagation delay between the DS-TT/NW-TT 415 and a next hop Ethernet station based on the cumulative rate ratio between the first clock and the second clock.

At 450, the DS-TT/NW-TT 415 may, in some implementations, transmit the converted propagation delay to the TSN AF 410. At 455, in such implementations, the TSN AF 410 may transmit or forward the converted propagation delay to the CNC entity 405. Further, although illustrated as providing the converted propagation delay measurements from the network entity to the CNC entity 405 after receiving the timing control information, the network entity may additionally or alternatively provide the converted propagation delay measurements to the CNC entity 405 prior to receiving the timing control information. In such examples in which the network entity provides the converted propagation delay measurements to the CNC entity 405 prior to receiving the timing control information, the CNC entity 405 may use the converted propagation delay measurements to calculate or otherwise determine the timing control information. For example, the CNC entity 405 may calculate or determine a gate schedule in accordance with the converted propagation delay measurements received from the network entity. Further, although the propagation delay is shown as being different from the timing control information in FIG. 4, the propagation delay may be equivalently referred to herein as timing control information (as the propagation delay is reported for gate scheduling).

At 460, the network entity (e.g., using the DS-TT/NW-TT 415) may communicate over a wireless communications network based on the timing control information and performing the mapping. Additionally or alternatively, the network entity (e.g., using the DS-TT/NW-TT 415) may communicate over a wired communications network based on the timing control information and performing the mapping. For example, for interaction between a DS-TT or a UE 115 with a 5GS (e.g., for receiving time information, timing control information, reporting of propagation delay, etc.), the network entity may communicate over a wireless communications network. For execution of gate schedules and the forwarding of data to devices attached to a DS-TT or an NW-TT based on the gate schedules, the network entity may communicate over a wired communications network. In some aspects, the NW-TT may exclusively communicate over a wired communications network. In some examples, and as a result of performing the operations described herein, the network entity may communicate over the wired or wireless communications network(s) in accordance with a gate schedule indicated by the timing control information and, as a result of performing the mapping, with time synchronization to one or more components of the TSN system.

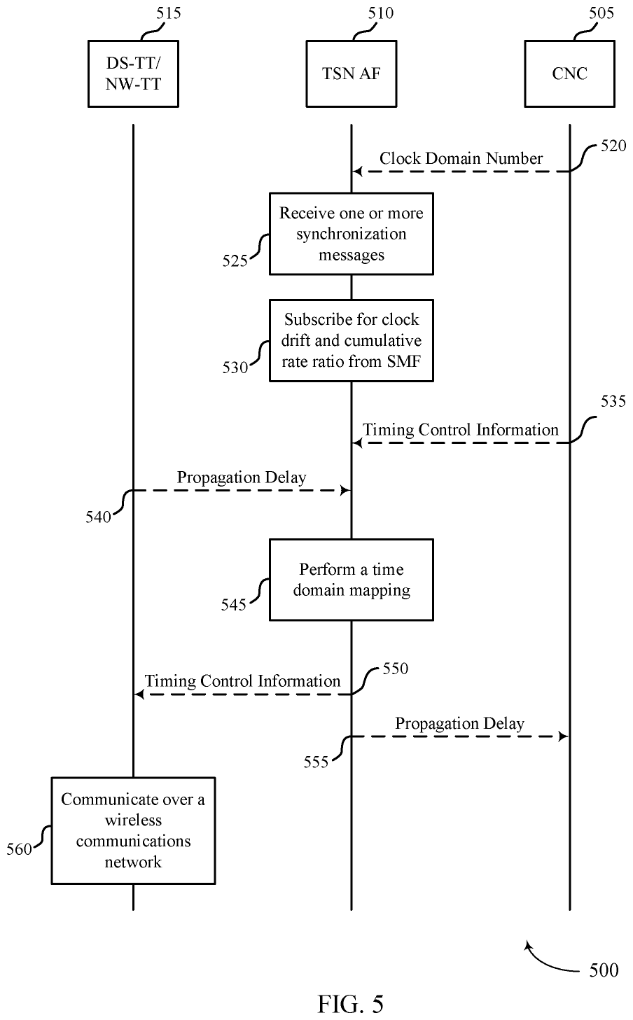

FIG. 5 illustrates an example of a process flow 500 that supports TSN support in a 5GS in accordance with aspects of the present disclosure. The process flow 500 may implement or be implemented to realize aspects of the wireless communications system 100, the TSN system 200, or the bridge interface 300. For example, the process flow 500 illustrates communication between a CNC entity 505 and a network entity including a TSN AF 510 and a DS-TT/NW-TT 515 (which may be an example of one or both of a DS-TT or an NW-TT), which may be examples of corresponding devices described herein, including with reference to FIGS. 1 through 3. In some examples, the network entity may perform, using the TSN AF 510, a time domain mapping between a first clock (e.g., a TSN clock) used by the CNC entity 505 and a second clock (e.g., a 5GS clock) used by the network entity.

In the following description of the process flow 500, the operations may be performed (such as reported or provided) in a different order than the order shown, or the operations performed by the example devices may be performed in different orders or at different times. Some operations also may be left out of the process flow 500, or other operations may be added to the process flow 500. Further, although some operations or signaling may be shown to occur at different times for discussion purposes, these operations may actually occur at the same time.

At 520, the TSN AF 510 may, in some implementations, receive an indication of a clock domain number from the CNC entity 505 corresponding to the first clock used by the CNC entity 505. Additionally or alternatively, the TSN AF 510 may be pre-configured with the clock domain number corresponding to the first clock used by the CNC entity 505.

At 525, the TSN AF 510 may receive, from a TSN clock manager (e.g., a TSN GM clock), one or more messages (e.g., synchronization messages) indicating the first clock used by the CNC entity 505. For example, the TSN AF 510 may receive one or more synchronization messages, such as PTP or gPTP messages, including or containing the clock domain number corresponding to the first clock used by the CNC entity 505 and the TSN AF 510 may, in some examples, forward the one or more synchronization messages to the DS-TT/NW-TT 515.

At 530, the TSN AF 510 may subscribe for clock drift and cumulative rate ratio information from an SMF. For example, the TSN AF 510 may transmit a request for a clock drift and a cumulative rate ratio between the first clock and the second clock. In some examples, the request may be associated with the clock domain number corresponding to the first clock used by the CNC entity 505. The TSN AF 510 may receive, responsive to the request, the clock drift and the cumulative rate ratio between the first clock and the second clock. Additional details relating to such a subscription to an SIF for clock drift and cumulative rate ratio information are described herein, including with reference to FIG. 3.

At 535, the TSN AF 510 may receive, from the CNC entity 505, timing control information including gate schedule timing information and gate schedule cycle information. In some examples, the gate schedule timing information and gate schedule cycle information may be defined in accordance with the first clock used by the CNC entity 505.

At 540, the TSN AF 510 may receive, from the DS-TT/NW-TT 515, a propagation delay between the DS-TT/NW-TT 515 and a next hop Ethernet station. In some examples, the propagation delay may be defined in accordance with the second clock used by the network entity. Further, although the propagation delay is shown as being different from the timing control information in FIG. 5, the propagation delay may be equivalently referred to herein as timing control information (as the propagation delay is reported for gate scheduling).

At 545, the TSN AF 510 may perform a time domain mapping between the first clock used by the CNC entity 505 and the second clock used by the network entity. For example, the TSN AF 510 may map the gate schedule timing information from the first clock used by the CNC entity 505 to the second clock used by the network entity based on the clock drift between the first clock and the second clock. Additionally or alternatively, the TSN AF 510 may map the gate schedule cycle information from the first clock used by the CNC entity 505 to the second clock used by the network entity based on the cumulative rate ratio between the first clock and the second clock. Additionally or alternatively, the TSN AF 510 may map the propagation delay from the second clock used by the network entity to the first clock used by the CNC entity 505 based on the cumulative rate ratio between the first clock and the second clock.

At 550, the TSN AF 510 may transmit, to the DS-TT/NW-TT 515, the (mapped or converted) gate schedule timing information and the (mapped or converted) gate schedule cycle information. As a result of performing the mapping between the first clock and the second clock at 545, the gate schedule timing information and the gate schedule cycle information that the TSN AF 510 provides to the DS-TT/NW-TT 515 may be defined in accordance with the second clock used by the network entity.

At 555, the TSN AF 510 may transmit, to the CNC entity 505, the (mapped or converted) propagation delay. As a result of performing the mapping between the first clock and the second clock at 545, the propagation delay that the TSN AF 510 provides to the CNC entity 505 may be defined in accordance with the first clock used by the CNC entity 505.

At 560, the network entity (e.g., using the DS-TT/NW-TT 515) may communicate over a wireless communications network based on the timing control information and performing the mapping. Additionally or alternatively, the network entity (e.g., using the DS-TT/NW-TT 515) may communicate over a wired communications network based on the timing control information and performing the mapping. For example, for interaction between a DS-TT or a UE 115 with a 5GS (e.g., for receiving time information, timing control information, reporting of propagation delay, etc.), the network entity may communicate over a wireless communications network. For execution of gate schedules and the forwarding of data to devices attached to a DS-TT or an NW-TT based on the gate schedules, the network entity may communicate over a wired communications network. In some aspects, the NW-TT may exclusively communicate over a wired communications network. In some examples, and as a result of performing the operations described herein, the network entity may communicate over the wired or wireless communications network(s) in accordance with a gate schedule indicated by the timing control information and, as a result of performing the mapping, with time synchronization to one or more components of the TSN system.

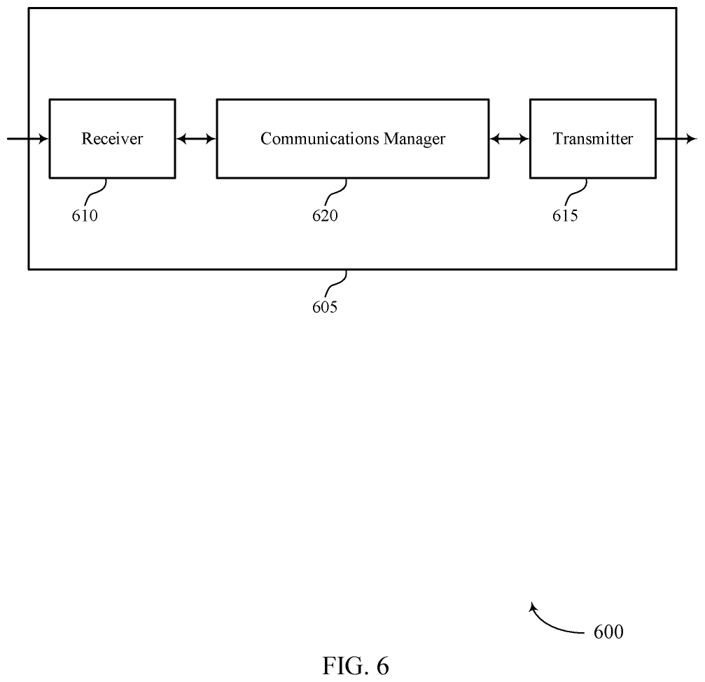

FIG. 6 shows a block diagram 600 of a device 605 that supports TSN support in a 5GS in accordance with aspects of the present disclosure. The device 605 may be an example of aspects of a network entity as described herein. The network entity may be an example of one or more components of or functionalities associated with a UE 115, a base station 105, a TRP, a relay node, or any other device that is capable of wireless communication. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to TSN support in a 5GS). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to TSN support in a 5GS). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of TSN support in a 5GS as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wired or wireless communication at a network entity in accordance with examples as disclosed herein. For example, the communications manager 620 may be configured as or otherwise support a means for receiving, from a TSN clock manager, one or more messages indicating a first clock used by a CNC entity configured to coordinate communications in a wired communications network that implements TSN. The communications manager 620 may be configured as or otherwise support a means for performing a time domain mapping between the first clock used by the CNC entity and a second clock used by the network entity that is configured to communicate over a wired or wireless communications network. The communications manager 620 may be configured as or otherwise support a means for communicating, by the network entity and over the wired or wireless communications network, one or more signals based on timing control information associated with the TSN and performing the time domain mapping.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for reduced processing, reduced power consumption, and more efficient utilization of communication resources.

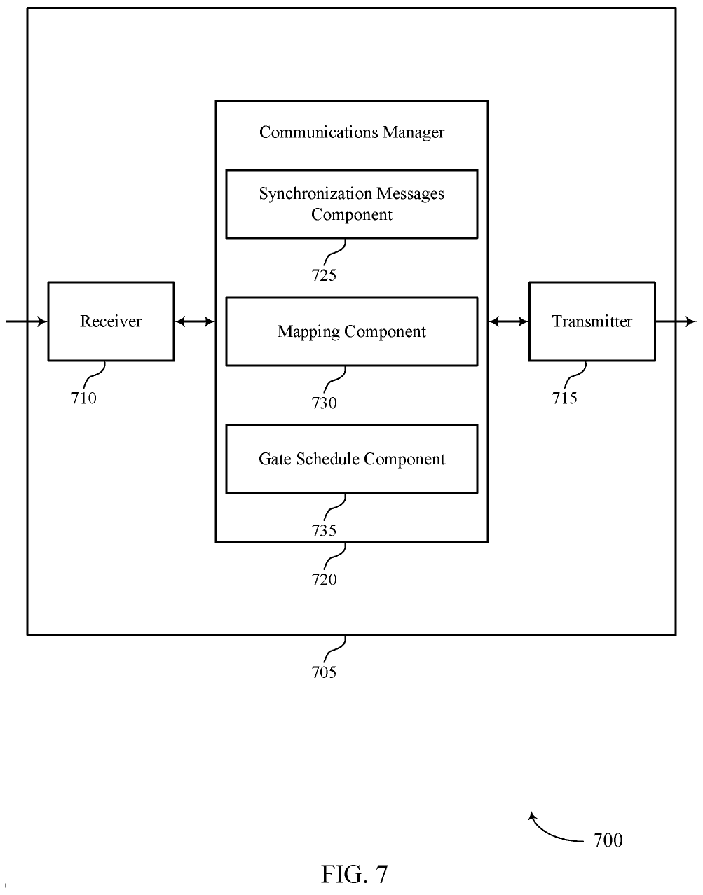

FIG. 7 shows a block diagram 700 of a device 705 that supports TSN support in a 5GS in accordance with aspects of the present disclosure. The device 705 may be an example of aspects of a device 605 or a network entity as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to TSN support in a 5GS). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to TSN support in a 5GS). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of TSN support in a 5GS as described herein. For example, the communications manager 720 may include a synchronization messages component 725, a mapping component 730, a gate schedule component 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wired or wireless communication at a network entity in accordance with examples as disclosed herein. The synchronization messages component 725 may be configured as or otherwise support a means for receiving, from a TSN clock manager, one or more messages indicating a first clock used by a CNC entity configured to coordinate communications in a wired communications network that implements TSN. The mapping component 730 may be configured as or otherwise support a means for performing a time domain mapping between the first clock used by the CNC entity and a second clock used by the network entity that is configured to communicate over a wired or wireless communications network. The gate schedule component 735 may be configured as or otherwise support a means for communicating, by the network entity and over the wired or wireless communications network, one or more signals based on timing control information associated with the TSN and performing the time domain mapping.

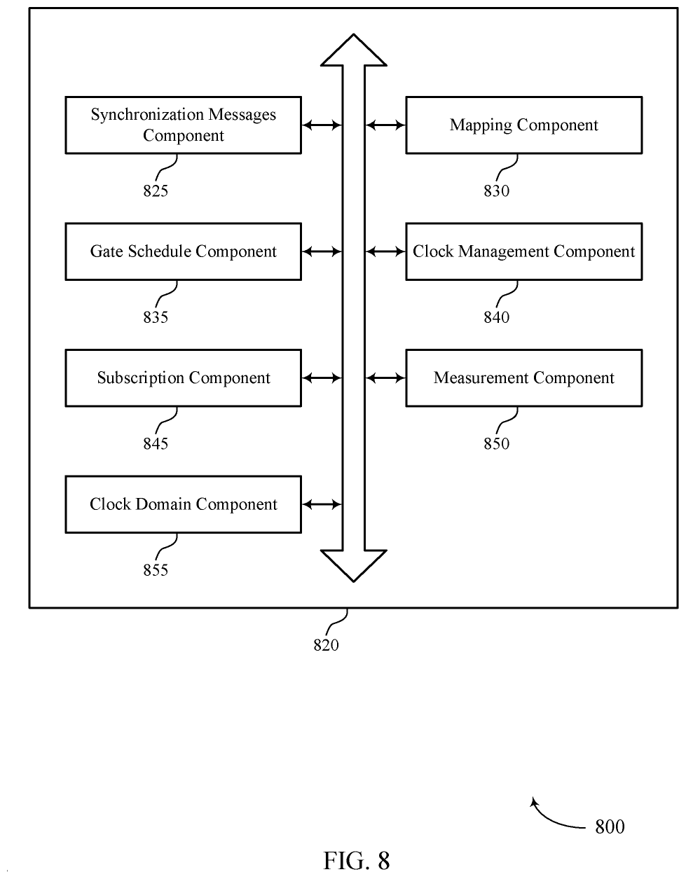

FIG. 8 shows a block diagram 800 of a communications manager 820 that supports TSN support in a 5GS in accordance with aspects of the present disclosure. The communications manager 820 may be an example of aspects of a communications manager 620, a communications manager 720, or both, as described herein. The communications manager 820, or various components thereof, may be an example of means for performing various aspects of TSN support in a 5GS as described herein. For example, the communications manager 820 may include a synchronization messages component 825, a mapping component 830, a gate schedule component 835, a clock management component 840, a subscription component 845, a measurement component 850, a clock domain component 855, or any combination thereof. Each of these components may communicate, directly or indirectly, with one another (e.g., via one or more buses).

The communications manager 820 may support wired or wireless communication at a network entity in accordance with examples as disclosed herein. The synchronization messages component 825 may be configured as or otherwise support a means for receiving, from a TSN clock manager, one or more messages indicating a first clock used by a CNC entity configured to coordinate communications in a wired communications network that implements TSN. The mapping component 830 may be configured as or otherwise support a means for performing a time domain mapping between the first clock used by the CNC entity and a second clock used by the network entity that is configured to communicate over a wired or wireless communications network. The gate schedule component 835 may be configured as or otherwise support a means for communicating, by the network entity and over the wired or wireless communications network, one or more signals based on timing control information associated with the TSN and performing the time domain mapping.

In some examples, the clock management component 840 may be configured as or otherwise support a means for calculating, by a DS-TT or an NW-TT of the network entity, a clock drift and a cumulative rate ratio between the first clock and the second clock based on receiving the one or more messages indicating the first clock used by the CNC entity and a clock domain number corresponding to the first clock used by the CNC entity, where performing the time domain mapping is based on calculating the clock drift and the cumulative rate ratio.

In some examples, the gate schedule component 835 may be configured as or otherwise support a means for receiving, from the CNC entity, the timing control information that includes gate schedule timing information and gate schedule cycle information defined in accordance with the first clock used by the CNC entity, where communicating the one or more signals is based on receiving the timing control information.

In some examples, to support performing the time domain mapping, the mapping component 830 may be configured as or otherwise support a means for mapping the gate schedule timing information from the first clock used by the CNC entity to the second clock used by the network entity based on the clock drift between the first clock and the second clock. In some examples, to support performing the time domain mapping, the mapping component 830 may be configured as or otherwise support a means for mapping the gate schedule cycle information from the first clock used by the CNC entity to the second clock used by the network entity based on the cumulative rate ratio between the first clock and the second clock.

In some examples, the measurement component 850 may be configured as or otherwise support a means for measuring a propagation delay between the DS-TT or the NW-TT and a next hop ethernet station, where the measuring is performed using the second clock, and where the timing control information includes the propagation delay.

In some examples, to support performing the time domain mapping, the mapping component 830 may be configured as or otherwise support a means for mapping the propagation delay from the second clock used by the network entity to the first clock used by the CNC entity based on the cumulative rate ratio between the first clock and the second clock.

In some examples, the gate schedule component 835 may be configured as or otherwise support a means for transmitting, to the CNC entity via a TSN AF entity, the propagation delay defined in accordance with the first clock used by the CNC entity, where the timing control information is based on the propagation delay between the DS-TT or the NW-TT and the next hop ethernet station.

In some examples, the clock domain component 855 may be configured as or otherwise support a means for receiving an indication of the clock domain number corresponding to the first clock used by the CNC entity. In some examples, the gate schedule component 835 may be configured as or otherwise support a means for processing the one or more messages based on receiving the indication of the clock domain number.

In some examples, the clock domain number is received from the CNC entity via a TSN AF entity.

In some examples, the clock domain number corresponding to the first clock used by the CNC entity is pre-configured at the DS-TT or the NW-TT.

In some examples, the subscription component 845 may be configured as or otherwise support a means for transmitting, by a TSN AF entity of the network entity and to an SMF entity of the network entity, a request for a clock drift and a cumulative rate ratio between the first clock and the second clock, the request associated with a clock domain number corresponding to the first clock used by the CNC entity. In some examples, the gate schedule component 835 may be configured as or otherwise support a means for receiving, from the SMF entity and based on the request associated with the clock domain number corresponding to the first clock, the clock drift and the cumulative rate ratio between the first clock and the second clock, where performing the time domain mapping is based on receiving the clock drift and the cumulative rate ratio.

In some examples, the gate schedule component 835 may be configured as or otherwise support a means for receiving, from the CNC entity, the timing control information that includes gate schedule timing information and gate schedule cycle information defined in accordance with the first clock used by the CNC entity, where communicating the one or more signals is based on receiving the timing control information includes.

In some examples, to support performing the time domain mapping, the mapping component 830 may be configured as or otherwise support a means for mapping the gate schedule timing information from the first clock used by the CNC entity to the second clock used by the network entity based on the clock drift between the first clock and the second clock. In some examples, to support performing the time domain mapping, the mapping component 830 may be configured as or otherwise support a means for mapping the gate schedule cycle information from the first clock used by the CNC entity to the second clock used by the network entity based on the cumulative rate ratio between the first clock and the second clock.

In some examples, the gate schedule component 835 may be configured as or otherwise support a means for transmitting, to a DS-TT or an NW-TT, the gate schedule timing information and the gate schedule cycle information defined in accordance with the second clock used by the network entity.

In some examples, the gate schedule component 835 may be configured as or otherwise support a means for receiving, from a DS-TT or an NW-TT, a propagation delay between the DS-TT or the NW-TT and a next hop ethernet station, the propagation delay defined in accordance with the second clock used by the network entity, where the timing control information includes the propagation delay, where the timing control information is based on the propagation delay between the DS-TT or the NW-TT and the next hop ethernet station.

In some examples, to support performing the time domain mapping, the mapping component 830 may be configured as or otherwise support a means for mapping the propagation delay from the second clock used by the network entity to the first clock used by the CNC entity based on the cumulative rate ratio between the first clock and the second clock.

In some examples, the gate schedule component 835 may be configured as or otherwise support a means for transmitting, to the CNC entity, the propagation delay defined in accordance with the first clock used by the CNC entity.

In some examples, the subscription component 845 may be configured as or otherwise support a means for receiving, from the SMF entity and based on the request associated with the clock domain number corresponding to the first clock, an updated clock drift and an updated cumulative rate ratio between the first clock and the second clock. In some examples, the mapping component 830 may be configured as or otherwise support a means for performing, for the timing control information, an updated time domain mapping between the first clock associated with the CNC entity and the second clock used by the network entity.

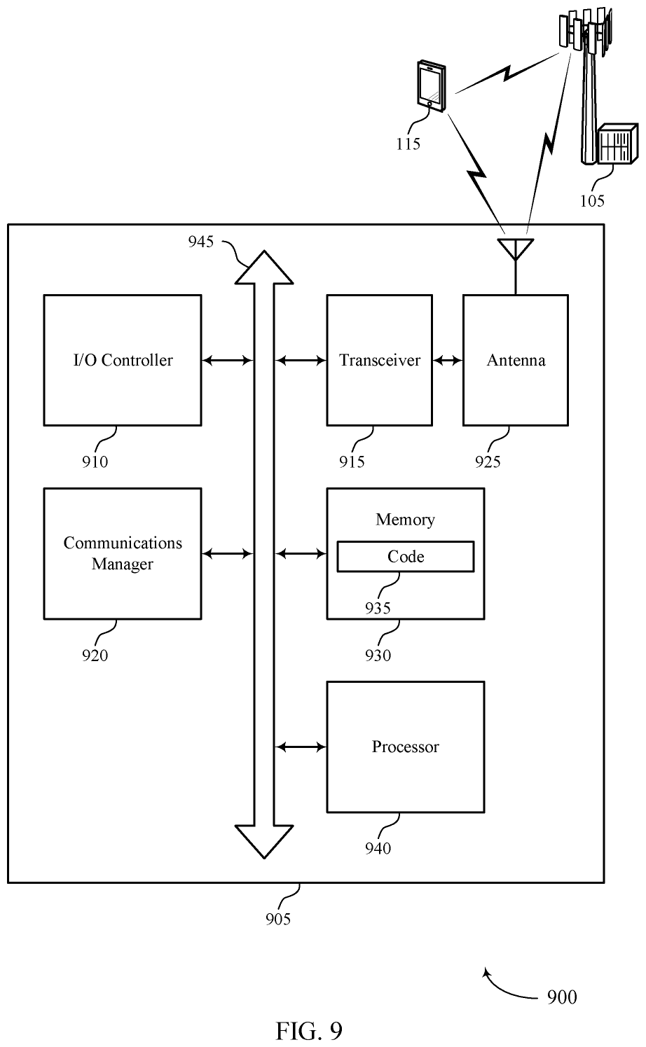

FIG. 9 shows a diagram of a system 900 including a device 905 that supports TSN support in a 5GS in accordance with aspects of the present disclosure. The device 905 may be an example of or include the components of a device 605, a device 705, or a network entity as described herein. The device 905 may communicate wirelessly with one or more base stations 105, UEs 115, other network entities, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting TSN support in a 5GS). For example, the device 905 or a component of the device 905 may include a processor 940 and memory 930 coupled to the processor 940, the processor 940 and memory 930 configured to perform various functions described herein.

The communications manager 920 may support wired or wireless communication at a network entity in accordance with examples as disclosed herein. For example, the communications manager 920 may be configured as or otherwise support a means for receiving, from a TSN clock manager, one or more messages indicating a first clock used by a CNC entity configured to coordinate communications in a wired communications network that implements TSN. The communications manager 920 may be configured as or otherwise support a means for performing a time domain mapping between the first clock used by the CNC entity and a second clock used by the network entity that is configured to communicate over a wired or wireless communications network. The communications manager 920 may be configured as or otherwise support a means for communicating, by the network entity and over the wired or wireless communications network, one or more signals based on timing control information associated with the TSN and performing the time domain mapping.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of TSN support in a 5GS as described herein, or the processor 940 and the memory 930 may be otherwise configured to perform or support such operations.

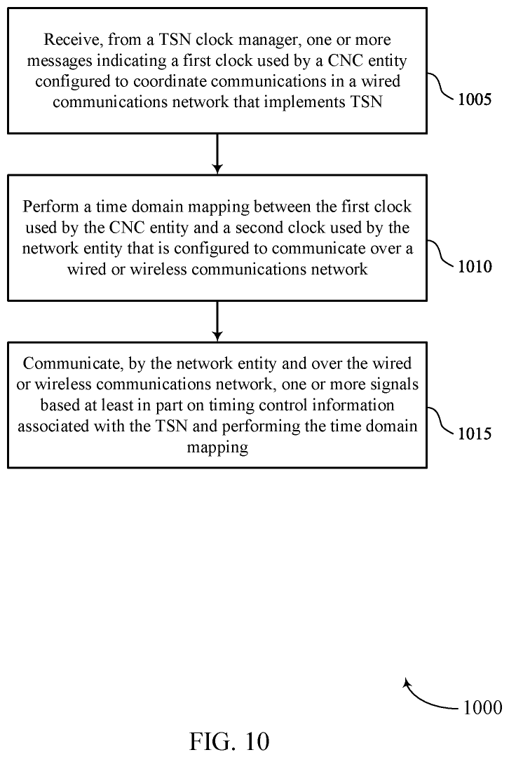

FIG. 10 shows a flowchart illustrating a method 1000 that supports TSN support in a 5GS in accordance with aspects of the present disclosure. The operations of the method 1000 may be implemented by a network entity or its components as described herein. For example, the operations of the method 1000 may be performed by a network entity as described with reference to FIGS. 1 through 9. In some examples, a network entity may execute a set of instructions to control the functional elements of the network entity to perform the described functions. Additionally or alternatively, the network entity may perform aspects of the described functions using special-purpose hardware.

At 1005, the method may include receiving, from a TSN clock manager, one or more messages indicating a first clock used by a CNC entity configured to coordinate communications in a wired communications network that implements TSN. The operations of 1005 may be performed in accordance with examples as disclosed herein. In some examples, aspects of the operations of 1005 may be performed by a synchronization messages component 825 as described with reference to FIG. 8.

At 1010, the method may include performing a time domain mapping between the first clock used by the CNC entity and a second clock used by the network entity that is configured to communicate over a wired or wireless communications network. The operations of 1010 may be performed in accordance with examples as disclosed herein. In some examples, aspects of the operations of 1010 may be performed by a mapping component 830 as described with reference to FIG. 8.

At 1015, the method may include communicating, by the network entity and over the wired or wireless communications network, one or more signals based at least in part on timing control information associated with the TSN and performing the time domain mapping. The operations of 1015 may be performed in accordance with examples as disclosed herein. In some examples, aspects of the operations of 1015 may be performed by a gate schedule component 835 as described with reference to FIG. 8.

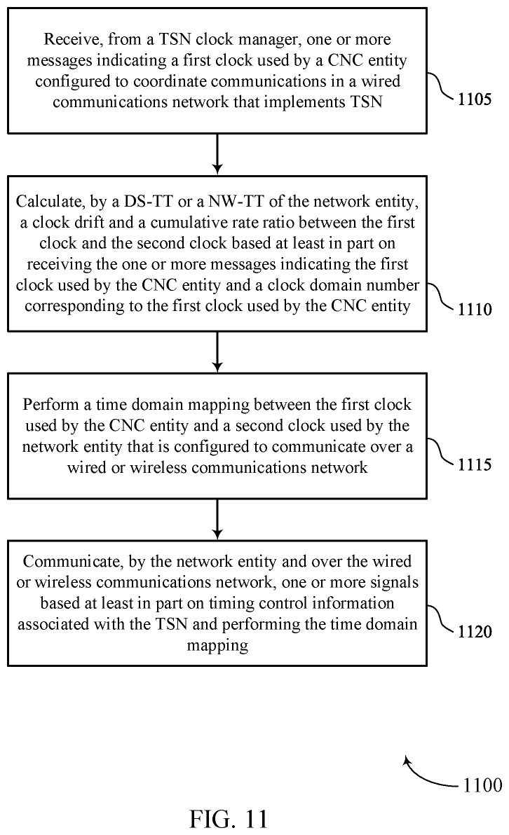

FIG. 11 shows a flowchart illustrating a method 1100 that supports TSN support in a 5GS in accordance with aspects of the present disclosure. The operations of the method 1100 may be implemented by a network entity or its components as described herein. For example, the operations of the method 1100 may be performed by a network entity as described with reference to FIGS. 1 through 9. In some examples, a network entity may execute a set of instructions to control the functional elements of the network entity to perform the described functions. Additionally or alternatively, the network entity may perform aspects of the described functions using special-purpose hardware.

At 1105, the method may include receiving, from a TSN clock manager, one or more messages indicating a first clock used by a CNC entity configured to coordinate communications in a wired communications network that implements TSN. The operations of 1105 may be performed in accordance with examples as disclosed herein. In some examples, aspects of the operations of 1105 may be performed by a synchronization messages component 825 as described with reference to FIG. 8.

At 1110, the method may include calculating, by a DS-TT or an NW-TT of the network entity, a clock drift and a cumulative rate ratio between the first clock and the second clock based at least in part on receiving the one or more messages indicating the first clock used by the CNC entity and a clock domain number corresponding to the first clock used by the CNC entity. The operations of 1110 may be performed in accordance with examples as disclosed herein. In some examples, aspects of the operations of 1110 may be performed by a clock management component 840 as described with reference to FIG. 8.

At 1115, the method may include performing a time domain mapping between the first clock used by the CNC entity and a second clock used by the network entity that is configured to communicate over a wired or wireless communications network. The operations of 1115 may be performed in accordance with examples as disclosed herein. In some examples, aspects of the operations of 1115 may be performed by a mapping component 830 as described with reference to FIG. 8.

At 1120, the method may include communicating, by the network entity and over the wired or wireless communications network, one or more signals based at least in part on timing control information associated with the TSN and performing the time domain mapping. The operations of 1120 may be performed in accordance with examples as disclosed herein. In some examples, aspects of the operations of 1120 may be performed by a gate schedule component 835 as described with reference to FIG. 8.

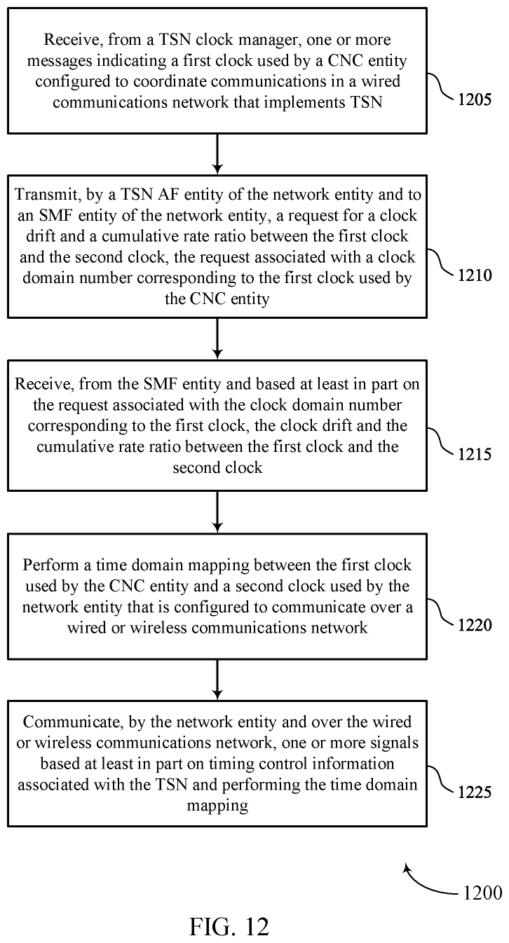

FIG. 12 shows a flowchart illustrating a method 1200 that supports TSN support in a 5GS in accordance with aspects of the present disclosure. The operations of the method 1200 may be implemented by a network entity or its components as described herein. For example, the operations of the method 1200 may be performed by a network entity as described with reference to FIGS. 1 through 9. In some examples, a network entity may execute a set of instructions to control the functional elements of the network entity to perform the described functions. Additionally or alternatively, the network entity may perform aspects of the described functions using special-purpose hardware.

At 1205, the method may include receiving, from a TSN clock manager, one or more messages indicating a first clock used by a CNC entity configured to coordinate communications in a wired communications network that implements TSN. The operations of 1205 may be performed in accordance with examples as disclosed herein. In some examples, aspects of the operations of 1205 may be performed by a synchronization messages component 825 as described with reference to FIG. 8.

At 1210, the method may include transmitting, by a TSN AF entity of the network entity and to an SMF entity of the network entity, a request for a clock drift and a cumulative rate ratio between the first clock and the second clock, the request associated with a clock domain number corresponding to the first clock used by the CNC entity. The operations of 1210 may be performed in accordance with examples as disclosed herein. In some examples, aspects of the operations of 1210 may be performed by a subscription component 845 as described with reference to FIG. 8.

At 1215, the method may include receiving, from the SMF entity and based at least in part on the request associated with the clock domain number corresponding to the first clock, the clock drift and the cumulative rate ratio between the first clock and the second clock. The operations of 1215 may be performed in accordance with examples as disclosed herein. In some examples, aspects of the operations of 1215 may be performed by a gate schedule component 835 as described with reference to FIG. 8.

At 1220, the method may include performing a time domain mapping between the first clock used by the CNC entity and a second clock used by the network entity that is configured to communicate over a wired or wireless communications network. The operations of 1220 may be performed in accordance with examples as disclosed herein. In some examples, aspects of the operations of 1220 may be performed by a mapping component 830 as described with reference to FIG. 8.

At 1225, the method may include communicating, by the network entity and over the wired or wireless communications network, one or more signals based on timing control information associated with the TSN and performing the time domain mapping. The operations of 1225 may be performed in accordance with examples as disclosed herein. In some examples, aspects of the operations of 1225 may be performed by a gate schedule component 835 as described with reference to FIG. 8.

The following provides an overview of aspects of the present disclosure:

Aspect 1: A method for wireless communication at a network entity, comprising: receiving, from a TSN clock manager, one or more messages indicating a first clock used by a CNC entity configured to coordinate communications in a wired communications network that implements TSN; performing a time domain mapping between the first clock used by the CNC entity and a second clock used by the network entity that is configured to communicate over a wired or wireless communications network; and communicating, by the network entity and over the wired or wireless communications network, one or more signals based at least in part on timing control information associated with the TSN and performing the time domain mapping.

Aspect 2: The method of aspect 1, further comprising: calculating, by a DS-TT or an NW-TT of the network entity, a clock drift and a cumulative rate ratio between the first clock and the second clock based at least in part on receiving the one or more messages indicating the first clock used by the CNC entity and a clock domain number corresponding to the first clock used by the CNC entity, wherein performing the time domain mapping is based at least in part on calculating the clock drift and the cumulative rate ratio.

Aspect 3: The method of aspect 2, further comprising: receiving, from the CNC entity, the timing control information that comprises gate schedule timing information and gate schedule cycle information defined in accordance with the first clock used by the CNC entity, wherein communicating the one or more signals is based at least in part on receiving the timing control information.

Aspect 4: The method of aspect 3, wherein performing the time domain mapping comprises: mapping the gate schedule timing information from the first clock used by the CNC entity to the second clock used by the network entity based at least in part on the clock drift between the first clock and the second clock; and mapping the gate schedule cycle information from the first clock used by the CNC entity to the second clock used by the network entity based at least in part on the cumulative rate ratio between the first clock and the second clock.

Aspect 5: The method of any of aspects 2 through 4, further comprising: measuring a propagation delay between the DS-TT or the NW-TT and a next hop ethernet station, wherein the measuring is performed using the second clock, and wherein the timing control information comprises the propagation delay.

Aspect 6: The method of aspect 5, wherein performing the time domain mapping comprises: mapping the propagation delay from the second clock used by the network entity to the first clock used by the CNC entity based at least in part on the cumulative rate ratio between the first clock and the second clock.

Aspect 7: The method of aspect 6, further comprising: transmitting, to the CNC entity via a TSN AF entity, the propagation delay defined in accordance with the first clock used by the CNC entity, wherein the timing control information is based at least in part on the propagation delay between the DS-TT or the NW-TT and the next hop ethernet station.

Aspect 8: The method of any of aspects 2 through 7, further comprising: receiving an indication of the clock domain number corresponding to the first clock used by the CNC entity; and processing the one or more messages based at least in part on receiving the indication of the clock domain number.

Aspect 9: The method of aspect 8, wherein the clock domain number is received from the CNC entity via a TSN AF entity.

Aspect 10: The method of any of aspects 2 through 9, wherein the clock domain number corresponding to the first clock used by the CNC entity is pre-configured at the DS-TT or the NW-TT.

Aspect 11: The method of any of aspects 1 through 10, further comprising: transmitting, by a TSN AF entity of the network entity and to a SMF entity of the network entity, a request for a clock drift and a cumulative rate ratio between the first clock and the second clock, the request associated with a clock domain number corresponding to the first clock used by the CNC entity; and receiving, from the SMF entity and based at least in part on the request associated with the clock domain number corresponding to the first clock, the clock drift and the cumulative rate ratio between the first clock and the second clock, wherein performing the time domain mapping is based at least in part on receiving the clock drift and the cumulative rate ratio.

Aspect 12: The method of aspect 11, further comprising: receiving, from the CNC entity, the timing control information that comprises gate schedule timing information and gate schedule cycle information defined in accordance with the first clock used by the CNC entity, wherein communicating the one or more signals is based at least in part on receiving the timing control information comprises.

Aspect 13: The method of aspect 12, wherein performing the time domain mapping comprises: mapping the gate schedule timing information from the first clock used by the CNC entity to the second clock used by the network entity based at least in part on the clock drift between the first clock and the second clock; and mapping the gate schedule cycle information from the first clock used by the CNC entity to the second clock used by the network entity based at least in part on the cumulative rate ratio between the first clock and the second clock.

Aspect 14: The method of aspect 13, further comprising: transmitting, to a DS-TT or an NW-TT, the gate schedule timing information and the gate schedule cycle information defined in accordance with the second clock used by the network entity.

Aspect 15: The method of any of aspects 11 through 14, further comprising: receiving, from a DS-TT or an NW-TT, a propagation delay between the DS-TT or the NW-TT and a next hop ethernet station, the propagation delay defined in accordance with the second clock used by the network entity, wherein the timing control information comprises the propagation delay, wherein the timing control information is based at least in part on the propagation delay between the DS-TT or the NW-TT and the next hop ethernet station.

Aspect 16: The method of aspect 15, wherein performing the time domain mapping comprises: mapping the propagation delay from the second clock used by the network entity to the first clock used by the CNC entity based at least in part on the cumulative rate ratio between the first clock and the second clock.

Aspect 17: The method of aspect 16, further comprising: transmitting, to the CNC entity, the propagation delay defined in accordance with the first clock used by the CNC entity.

Aspect 18: The method of any of aspects 11 through 17, further comprising: receiving, from the SMF entity and based at least in part on the request associated with the clock domain number corresponding to the first clock, an updated clock drift and an updated cumulative rate ratio between the first clock and the second clock; and performing, for the timing control information, an updated time domain mapping between the first clock associated with the CNC entity and the second clock used by the network entity.

Aspect 19: An apparatus for wireless communication at a network entity, comprising a processor; memory coupled with the processor; and instructions stored in the memory and executable by the processor to cause the apparatus to perform a method of any of aspects 1 through 18.

Aspect 20: An apparatus for wireless communication at a network entity, comprising at least one means for performing a method of any of aspects 1 through 18.

Aspect 21: A non-transitory computer-readable medium storing code for wireless communication at a network entity, the code comprising instructions executable by a processor to perform a method of any of aspects 1 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for communication at a network entity, comprising:
receiving, from a time sensitive networking clock manager, one or more messages indicating a first clock used by a centralized network configuration entity configured to coordinate communications in a wired communications network that implements time sensitive networking;
performing a time domain mapping between the first clock used by the centralized network configuration entity and a second clock used by the network entity that is configured to communicate over a wired or wireless communications network; and
communicating, by the network entity and over the wired or wireless communications network, one or more signals based at least in part on timing control information associated with the time sensitive networking and performing the time domain mapping.

2. The method of claim 1, further comprising:
calculating, by a device-side time sensitive networking translator or a network-side time sensitive networking translator of the network entity, a clock drift and a cumulative rate ratio between the first clock and the second clock based at least in part on receiving the one or more messages indicating the first clock used by the centralized network configuration entity and a clock domain number corresponding to the first clock used by the centralized network configuration entity, wherein performing the time domain mapping is based at least in part on calculating the clock drift and the cumulative rate ratio.

3. The method of claim 2, further comprising:
receiving, from the centralized network configuration entity, the timing control information that comprises gate schedule timing information and gate schedule cycle information defined in accordance with the first clock used by the centralized network configuration entity, wherein communicating the one or more signals is based at least in part on receiving the timing control information.

4. The method of claim 3, wherein performing the time domain mapping comprises:
mapping the gate schedule timing information from the first clock used by the centralized network configuration entity to the second clock used by the network entity based at least in part on the clock drift between the first clock and the second clock; and
mapping the gate schedule cycle information from the first clock used by the centralized network configuration entity to the second clock used by the network entity based at least in part on the cumulative rate ratio between the first clock and the second clock.

5. The method of claim 2, further comprising:
measuring a propagation delay between the device-side time sensitive networking translator or the network-side time sensitive networking translator and a next hop ethernet station, wherein the measuring is performed using the second clock, and wherein the timing control information comprises the propagation delay.

6. The method of claim 5, wherein performing the time domain mapping comprises:
mapping the propagation delay from the second clock used by the network entity to the first clock used by the centralized network configuration entity based at least in part on the cumulative rate ratio between the first clock and the second clock.

7. The method of claim 6, further comprising:
transmitting, to the centralized network configuration entity via a time sensitive networking application function entity, the propagation delay defined in accordance with the first clock used by the centralized network configuration entity, wherein the timing control information is based at least in part on the propagation delay between the device-side time sensitive networking translator or the network-side time sensitive networking translator and the next hop ethernet station.

8. The method of claim 2, further comprising:
receiving an indication of the clock domain number corresponding to the first clock used by the centralized network configuration entity; and
processing the one or more messages based at least in part on receiving the indication of the clock domain number.

9. The method of claim 2, wherein the clock domain number corresponding to the first clock used by the centralized network configuration entity is pre-configured at the device-side time sensitive networking translator or the network-side time sensitive networking translator.

10. The method of claim 1, further comprising:
transmitting, by a time sensitive networking application function entity of the network entity and to a session management function entity of the network entity, a request for a clock drift and a cumulative rate ratio between the first clock and the second clock, the request associated with a clock domain number corresponding to the first clock used by the centralized network configuration entity; and
receiving, from the session management function entity and based at least in part on the request associated with the clock domain number corresponding to the first clock, the clock drift and the cumulative rate ratio between the first clock and the second clock, wherein performing the time domain mapping is based at least in part on receiving the clock drift and the cumulative rate ratio.

11. The method of claim 10, further comprising:
receiving, from the centralized network configuration entity, the timing control information that comprises gate schedule timing information and gate schedule cycle information defined in accordance with the first clock used by the centralized network configuration entity, wherein communicating the one or more signals is based at least in part on receiving the timing control information comprises.

12. The method of claim 11, wherein performing the time domain mapping comprises:
mapping the gate schedule timing information from the first clock used by the centralized network configuration entity to the second clock used by the network entity based at least in part on the clock drift between the first clock and the second clock; and
mapping the gate schedule cycle information from the first clock used by the centralized network configuration entity to the second clock used by the network entity based at least in part on the cumulative rate ratio between the first clock and the second clock.

13. The method of claim 12, further comprising:
transmitting, to a device-side time sensitive networking translator or a network-side time sensitive networking translator, the gate schedule timing information and the gate schedule cycle information defined in accordance with the second clock used by the network entity.

14. The method of claim 10, further comprising:
receiving, from a device-side time sensitive networking translator or a network-side time sensitive networking translator, a propagation delay between the device-side time sensitive networking translator or the network-side time sensitive networking translator and a next hop ethernet station, the propagation delay defined in accordance with the second clock used by the network entity, wherein the timing control information comprises the propagation delay, wherein the timing control information is based at least in part on the propagation delay between the device-side time sensitive networking translator or the network-side time sensitive networking translator and the next hop ethernet station.

15. The method of claim 14, wherein performing the time domain mapping comprises:
mapping the propagation delay from the second clock used by the network entity to the first clock used by the centralized network configuration entity based at least in part on the cumulative rate ratio between the first clock and the second clock.

16. The method of claim 15, further comprising:
transmitting, to the centralized network configuration entity, the propagation delay defined in accordance with the first clock used by the centralized network configuration entity.

17. The method of claim 10, further comprising:
receiving, from the session management function entity and based at least in part on the request associated with the clock domain number corresponding to the first clock, an updated clock drift and an updated cumulative rate ratio between the first clock and the second clock; and
performing, for the timing control information, an updated time domain mapping between the first clock associated with the centralized network configuration entity and the second clock used by the network entity.

18. An apparatus for communication at a network entity, comprising:
a processor; and
a memory coupled with the processor, wherein the memory comprises instructions executable by the processor to cause the apparatus to:
receive, from a time sensitive networking clock manager, one or more messages indicating a first clock used by a centralized network configuration entity configured to coordinate communications in a wired communications network that implements time sensitive networking;
perform a time domain mapping between the first clock used by the centralized network configuration entity and a second clock used by the network entity that is configured to communicate over a wired or wireless communications network; and
communicate, by the network entity and over the wired or wireless communications network, one or more signals based at least in part on timing control information associated with the time sensitive networking and performing the time domain mapping.

19. The apparatus of claim 18, wherein the instructions are further executable by the processor to cause the apparatus to:
calculate, by a device-side time sensitive networking translator or a network-side time sensitive networking translator of the network entity, a clock drift and a cumulative rate ratio between the first clock and the second clock based at least in part on receiving the one or more messages indicating the first clock used by the centralized network configuration entity and a clock domain number corresponding to the first clock used by the centralized network configuration entity, wherein performing the time domain mapping is based at least in part on calculating the clock drift and the cumulative rate ratio.

20. The apparatus of claim 19, wherein the instructions are further executable by the processor to cause the apparatus to:
receive, from the centralized network configuration entity, the timing control information that comprises gate schedule timing information and gate schedule cycle information defined in accordance with the first clock used by the centralized network configuration entity, wherein communicating the one or more signals is based at least in part on receiving the timing control information.

21. The apparatus of claim 20, wherein the instructions to perform the time domain mapping are executable by the processor to cause the apparatus to:
map the gate schedule timing information from the first clock used by the centralized network configuration entity to the second clock used by the network entity based at least in part on the clock drift between the first clock and the second clock; and
map the gate schedule cycle information from the first clock used by the centralized network configuration entity to the second clock used by the network entity based at least in part on the cumulative rate ratio between the first clock and the second clock.

22. The apparatus of claim 19, wherein the instructions are further executable by the processor to cause the apparatus to:
measure a propagation delay between the device-side time sensitive networking translator or the network-side time sensitive networking translator and a next hop ethernet station, wherein the measuring is performed using the second clock, and wherein the timing control information comprises the propagation delay.

23. The apparatus of claim 22, wherein the instructions to perform the time domain mapping are executable by the processor to cause the apparatus to:
map the propagation delay from the second clock used by the network entity to the first clock used by the centralized network configuration entity based at least in part on the cumulative rate ratio between the first clock and the second clock.

24. The apparatus of claim 18, wherein the instructions are further executable by the processor to cause the apparatus to:
transmit, by a time sensitive networking application function entity of the network entity and to a session management function entity of the network entity, a request for a clock drift and a cumulative rate ratio between the first clock and the second clock, the request associated with a clock domain number corresponding to the first clock used by the centralized network configuration entity; and
receive, from the session management function entity and based at least in part on the request associated with the clock domain number corresponding to the first clock, the clock drift and the cumulative rate ratio between the first clock and the second clock, wherein performing the time domain mapping is based at least in part on receiving the clock drift and the cumulative rate ratio.

25. The apparatus of claim 24, wherein the instructions are further executable by the processor to cause the apparatus to:
receive, from the centralized network configuration entity, the timing control information that comprises gate schedule timing information and gate schedule cycle information defined in accordance with the first clock used by the centralized network configuration entity, wherein communicating the one or more signals is based at least in part on receiving the timing control information comprises.

26. The apparatus of claim 25, wherein the instructions to perform the time domain mapping are executable by the processor to cause the apparatus to:
map the gate schedule timing information from the first clock used by the centralized network configuration entity to the second clock used by the network entity based at least in part on the clock drift between the first clock and the second clock; and
map the gate schedule cycle information from the first clock used by the centralized network configuration entity to the second clock used by the network entity based at least in part on the cumulative rate ratio between the first clock and the second clock.

27. The apparatus of claim 24, wherein the instructions are further executable by the processor to cause the apparatus to:
receive, from a device-side time sensitive networking translator or a network-side time sensitive networking translator, a propagation delay between the device-side time sensitive networking translator or the network-side time sensitive networking translator and a next hop ethernet station, the propagation delay defined in accordance with the second clock used by the network entity, wherein the timing control information comprises the propagation delay, wherein the timing control information is based at least in part on the propagation delay between the device-side time sensitive networking translator or the network-side time sensitive networking translator and the next hop ethernet station.

28. The apparatus of claim 27, wherein the instructions to perform the time domain mapping are executable by the processor to cause the apparatus to:
map the propagation delay from the second clock used by the network entity to the first clock used by the centralized network configuration entity based at least in part on the cumulative rate ratio between the first clock and the second clock.

29. An apparatus for communication at a network entity, comprising:
means for receiving, from a time sensitive networking clock manager, one or more messages indicating a first clock used by a centralized network configuration entity configured to coordinate communications in a wired communications network that implements time sensitive networking;
means for performing a time domain mapping between the first clock used by the centralized network configuration entity and a second clock used by the network entity that is configured to communicate over a wired or wireless communications network; and
means for communicating, by the network entity and over the wired or wireless communications network, one or more signals based at least in part on timing control information associated with the time sensitive networking and performing the time domain mapping.

30. A non-transitory computer-readable medium storing code for communication at a network entity, wherein the code comprises instructions executable by a processor to:
receive, from a time sensitive networking clock manager, one or more messages indicating a first clock used by a centralized network configuration entity configured to coordinate communications in a wired communications network that implements time sensitive networking;
perform a time domain mapping between the first clock used by the centralized network configuration entity and a second clock used by the network entity that is configured to communicate over a wired or wireless communications network; and
communicate, by the network entity and over the wired or wireless communications network, one or more signals based at least in part on timing control information associated with the time sensitive networking and performing the time domain mapping.
